(19) United States
(12) Patent Application Publication
(10) Pub. No.: US 2005/0040283 A1
(43) Pub. Date: Feb. 24, 2005

(54) Method of propulsion and attitude control in fluid environments and vehicles utilizing said method

(75) Inventor: Richard Tyler Frazer, Montesano, WA (US)

Correspondence Address: Richard Tyler Frazer, 9 Poplar Road # 41, Montesano, WA, 98563, US

(73) Assignee: Richard Tyler Frazer, Montesano, WA (US)

(21) Appl. No.: 10/642,554

(22) Filed: Aug. 18, 2003

(51) Int. Cl. B64C 15/02

(52) U.S. Cl. 244/12.3

(57) ABSTRACT

A method of propulsion and attitude control in fluid environments is disclosed by examples of preferred embodiments of vehicles utilizing said methodology. The preferred embodiment of a vehicle utilizing said invention comprises at least one pair of left and right wing assemblies of an airfoil profile separated by a fuselage that combine to form a fluid dynamic body. Each wing assembly houses within its interior at least two longitudinally adjacent, counter-rotating drive-fans mounted on fixed approximately vertical axes that are capable of being powered by various means. Each wing assembly has operable interior and exterior venting means that control fluid flow to, from and between respective drive-fans. Each wing assembly has control surfaces at its trailing edge and is itself hinged to the fuselage with means to change the dihedral of the wing assembly. Each wing assembly has surfaces of designed permeability that create a dynamic laminar flow envelope about the vehicle. The fuselage comprises a forward cockpit/cabin area and a fluid channel located laterally between left and right wing assemblies with means to control flow between said wing assemblies. The preferred embodiment may be constructed to any scale while using various construction techniques common knowledge to marine and aircraft construction, as well as easily modified to suit role and performance.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND OF THE INVENTION

The current invention relates, in general, to methods of propulsion and attitude control applicable to: marine submersibles, marine surface vehicles, surface-effect vehicles, conventional aircraft, and V/STOL aircraft. More specifically, the invention relates to a method of propulsion and attitude control that utilizes longitudinally adjacent, counter-rotating, drive-fans mounted on fixed, approximately vertical axes within airfoil wing assemblies of controllable dihedral.

The majority of designs and patents related to propulsion and attitude control in fluid environments are specialized to function in three distinct environments: marine, surface-effect and atmospheric flight. Submersibles, surface marine vehicles, surface-effect vehicles, fixed-wing aircraft, rotary wing aircraft and a wide assortment of theoretical and conceptual vehicles tend to use methods of propulsion and control that are not compatible with each other although there are hybrid type vehicles designed to function in more than one environment with less than optimum performance in these environments. Though there are many designs and patents that utilize many different means for propulsion and attitude control in fluid environments, as the current invention utilizes drive-fans mounted upon fixed, approximately vertical axes, only designs and patents that utilize a fan(s), impeller(s), propeller(s) or rotor(s) mounted upon a fixed, approximately vertical axis or axes for propulsion and attitude control shall be addressed in general as prior art.

Marine propulsion and attitude control related to the current invention is relegated to water jet-pumps, which utilize impellers mounted upon fixed, approximately vertical axes that ingest fluid by the axial suction of the impellers and then exhaust fluid by the centrifugal thrust of the same impeller to create longitudinal propulsion. The fluid exhaust may then be directed by controlled pivoting of the exhaust stream to create two-dimensional attitude control, essentially left/right turning. This method of propulsion and attitude control is common to jet-sled boats and personal watercraft and on a limited basis, larger surface marine vehicles. Because this method of propulsion and attitude control is less efficient than common screw-type propellers, mounted upon axes parallel with the longitudinal centerline of the vehicle, there is no known use of this method for marine submersibles. Along with the reduction of efficiency, this method has other inherent disadvantages, including: the relatively small pump intake(s), which are located at the bottom of the vehicle so as to remain in the fluid stream upon which the pumps act upon, may become obstructed, debris may be ingested by the impeller, damaging the impeller, seals, bearings and/or other drive components and said method requires the impeller to be driven at a high rate of speed for optimum performance, which in turn reduces the lifespan of many drive components. This method of propulsion is specifically designed to operate in a marine environment and may not be modified in any known way to transcend said environment without other means of propulsion and control.

Surface-effect propulsion and attitude control related to the current invention is relegated to hovercraft design, which utilizes an aircraft-type propeller(s) or fan(s) mounted upon a fixed, approximately vertical axis or axes to fill a flexible skirt structure with air, creating a static cushion of air between the vehicle and the surface over which it is traveling. In some designs the air ingested by the fan(s) or propeller(s) may be selectively vectored to create longitudinal thrust and attitude control, however, it is more common for said vehicle to have separate means for these functions including: an aircraft propeller or propellers, mounted upon an axis or axes parallel with the longitudinal centerline of the vehicle for longitudinal propulsion and a vertical rudder or rudders for left/right turning control. Along with the assumed necessity of separate means for lift and longitudinal propulsion and attitude control, the disadvantages common to hovercraft design include the inability to operate safely and efficiently: in rough water conditions, high winds, on steep grades, and over large obstacles and rough terrain relative to the size of the vehicle. There have been recent developments in which hovercraft have been modified with the addition of shortened wing structures to allow for surface-effect flight.

Atmospheric flight propulsion and attitude control related to the current invention may be divided into three categories: rotary-wing aircraft; fixed-wing aircraft that utilize a fan(s), propeller(s) or rotor(s) mounted upon a fixed, approximately vertical axis or axes for V/STOL lift and low-speed maneuvering while utilizing other means for longitudinal propulsion and flight attitude control; and fixed-wing aircraft that utilize fans, propellers or rotors mounted upon fixed, approximately vertical axes for V/STOL lift, longitudinal propulsion and, to different extents, attitude control.

Rotary-wing aircraft, which include helicopters, the operation and design of which is common knowledge to those involved in aeronautical engineering, have been the most successful and widely used of these designs. There are several disadvantages to rotary-wing aircraft that the current invention addresses. Rotary-wing aircraft have large exposed rotors, relatively non-lifting fuselages, lower longitudinal velocity than similarly powered and weighted fixed-wing aircraft due to the aerodynamic interaction of the main rotor with the air stream as the forward speed of the vehicle approaches the speed of the rotor as it rotates aft-ward and a great deal of the available horsepower to a given vehicle is utilized to counteract the centrifugal force created by the main rotor.

Other types of atmospheric flight propulsion and control related to the invention are mostly theoretical or have been proven to be unfeasible. As the current invention utilizes drive-fans, propellers and/or rotors mounted upon fixed, approximately vertical axes for V/STOL lift, longitudinal propulsion and in conjunction with conventional-type control surfaces for attitude control, only similar patents shall be addressed, in particular, as prior art.

Like the current invention, U.S. Pat. No. 2,461,425, U.S. Pat. No. 2,753,132, U.S. Pat. No. 3,082,977, U.S. Pat. No. 3,120,362, U.S. Pat. No. 3,179,353, U.S. Pat. No. 3,561,701, U.S. Pat. No. 4,125,232, U.S. Pat. No. 5,454,531, French Pat. No. 959,441, French Pat. No. 1,382,124, United Kingdom Pat. No. 942,339 and United Kingdom Pat. No. 2,261,203A, have sought to utilize drive-fans mounted on fixed, approximately vertical axes for lift, longitudinal and lateral propulsion and attitude control. However, taken in conjunction or individually, these patents do not share the same features, in the same arrangement, as constitute the unique method of propulsion and attitude control of the current invention, which shall be briefly described in the following section.

### BRIEF SUMMARY OF THE INVENTION

The invention disclosed is a method of propulsion and attitude control applicable to all fluid environments. Longitudinal propulsion is created by longitudinally adjacent, counter-rotating, drive-fans mounted on approximately vertical axes within airfoil wing assemblies which draw fluid from the ambient environment through controllable louvered vanes and vents, fixed structures of variable permeability, and door-like sub-wing assemblies located on the exterior of the wing assemblies as well as from vents arranged around the periphery of the cylindrical shrouds surrounding each drive-fan. Fluid is then controllably exhausted by shroud venting means through exhaust vents at the aft and outer wingtips of the wing assemblies by the centrifugal thrust of the drive-fans. Longitudinal propulsion as described is augmented by the swirl effect of the drive-fans on the surrounding ambient fluid medium as fixed permeable or controllable louvered vane intakes and exhausts that are located directly above and below the drive-fans are arranged such that the drive-fans are exposed to the ambient fluid medium at the aft-ward rotation of the drive-fans.

V/STOL lift propulsion is likewise derived from the controlled influx of fluid through the means mentioned above that is then controllably exhausted downward approximately perpendicular to the longitudinal line of the vehicle through venting means located on the bottom of the wing assemblies. Lift propulsion as described is augmented by the heat derived from primary drive components, which is drawn into the drive-fans and exhausted vertically downward to create increased lift.

By giving the drive-fan blades a negative pitch, the above-mentioned lift functions are reversed and controllable, submersible descent may be achieved, while longitudinal propulsion and attitude control functions remain the same.

By regulating the fluid flow to and from the respective drive-fans, between drive-fans of the same wing assembly and between the respective wing assemblies by intake and exhaust venting means mentioned above to control longitudinal and lift propulsion in conjunction with actuating the dihedral of the wing assemblies, trailing edge control surfaces, and the vectoring of longitudinal thrust from the aft and wing-tip exhaust vents, coordinated control of lift, pitch, roll, yaw, and lateral and longitudinal thrust is achieved.

The preferred embodiment of a vehicle propelled and controlled by the method of the invention integrates at least one left and one right wing assembly with a centrally located fuselage to create a fluid dynamic body. The structural geometry of a preferred embodiment of a vehicle utilizing the invention is substantially triangulated longitudinally and laterally, with the wing assemblies being constructed around cylindrical drive-fan shrouds, which are in turn arranged within a hexagonal-cell framework. The intersection of lines bisecting these hexagonal-cell structures serve as centers for the mounting of the drive-fans and drive components. Wherever possible, lateral and longitudinal triangulation is used for strength and conservation of weight, while the geometry of the invention also allows for variable mounting points for vertical, structural triangulation where necessary.

Each respective wing assembly is of an airfoil profile that may be modified in camber, thickness and lateral curvature to suit specific performance and role requirements. Each wing assembly houses at least two longitudinally adjacent, counter-rotating, drive-fans mounted on fixed, approximately vertical axes within their own respective cylindrical shrouds. Each shroud has operable venting means arranged around the periphery that regulate the direction and volume of centrifugal fluid flow to and from each respective drive-fan. Each wing assembly has controllable exterior venting located directly above and below the drive-fans and/or fixed permeable, semi-permeable and non-permeable surfaces that regulate fluid flow over and under each respective wing assembly to create a dynamic laminar flow envelope around the vehicle as well as regulating the direction and volume of fluid flow to and from the drive-fans to create coordinated lift, pitch, roll and yaw movements as well as longitudinal and lateral thrust and braking. Each wing assembly has at least one leading edge vent that may be controlled to regulate fluid flow into the forward drive-fan shroud. Each wing assembly has venting means located adjacent to the fuselage to allow heat to be drawn from primary drive components in the case of utilizing electric, hydraulic, and/or steam motors on the drive-fans and to allow for fluid flow from venting structures and/or fixed permeable or semi-permeable structures located on the leading edge and top of the fuselage. Each wing assembly has at least one controllable exhaust vent located on the outside edge of the wing assembly that regulates fluid flow from the adjacent drive-fan shroud to control lift, pitch, roll and yaw as well as longitudinal and lateral thrust. Each wing assembly has at least one controllable aft exhaust vent that regulates fluid flow from the aft drive-fan shroud to control lift, pitch, roll and yaw as well as longitudinal and lateral thrust.

Each wing assembly has at least one trailing edge surface, which may function as an split-type aileron or flap, mounted on the top and/or bottom of the wing assembly to control pitch, roll and yaw movements. Each wing assembly has at least one top and/or bottom aft tail surface, which may function as an split-type aileron or flap, to control the vectoring of fluid exhaust from the aft exhaust vent as well as effecting pitch, roll and yaw movements.

Each wing assembly may be hinged to pivot up and/or down, thereby effecting the dihedral of the entire wing assembly, to control yaw, roll and pitch movements, lateral center of gravity and fluid flow to and from each respective drive-fan shroud and between left and right wing assemblies.

The fuselage houses a central, forward cabin/cockpit, with primary drive components, in the case of utilizing electric, hydraulic and/or steam drive motors on the drive-fans, being located between the cabin/cockpit and wing assemblies.

The area directly aft of the useable cockpit/cabin area may serve as a fluid passageway between wing assemblies which may be used to control fluid flow between left and right wing assemblies to coordinate lift, pitch, roll, yaw, lateral thrust and fluid pressure variances which occur between left and right wing assemblies during different movements.

The surfaces located directly above said area may be of a permeable or semi-permeable construction. Fuselage top surfaces adjacent to the wing assemblies may be of permeable or semi-permeable construction as fluid is also inducted into the wing assembly drive-fans from the fuselage through venting means located between the fuselage and the wing assemblies.

Located at the extreme aft of the fuselage may be a vertical tail and rudder assembly to control turning movements that may also consist of a horizontal elevator or split elevators mounted to the top of the tail assembly to effect lift, pitch, roll and yaw.

An emphasis on simplicity, modularity and flexibility of construction, performance and role is inherent in the design of the invention. An added emphasis is on the scalability of said invention, with overall performance increasing with the scale of vehicles utilizing the invention.

### BRIEF DESCRIPTION OF THE DRAWINGS

FIG. 1a, depicts a top perspective view of a twin, individually-shrouded, drive-fan per wing assembly model of a preferred embodiment of a vehicle utilizing the invention. Such a vehicle shall henceforth be referred to as a “two-cell vehicle.”

FIG. 1b, depicts a bottom perspective view of a two-cell vehicle.

FIG. 1c, depicts a perspective view of the structural geometry of a two cell vehicle.

FIG. 2a, depicts a top perspective view of a triple, individually-shrouded, drive-fan per wing assembly model of a preferred embodiment of a vehicle utilizing the invention. Such a vehicle shall henceforth be referred to as a “three-cell vehicle.”

FIG. 2b, depicts a bottom perspective view of a three-cell vehicle.

FIG. 2c, depicts a perspective view of the structural geometry of a three-cell vehicle.

FIG. 3a, depicts a top perspective view of a quadruple, individually-shrouded, drive-fan per wing assembly model of a preferred embodiment of a vehicle utilizing the invention. Such a vehicle shall henceforth be referred to as a “four-cell vehicle.”

FIG. 3b, depicts a bottom perspective view of a four-cell vehicle.

FIG. 3c, depicts a perspective view of the structural geometry of a four-cell vehicle.

FIG. 4a, depicts a top view of the structural geometry of a two-cell vehicle. FIG. 4b through FIG. 4e, depict general modification that may be made to the fuselage.

FIG. 5a and FIG. 5b, depict side and top views, respectively, of a single pilot cockpit layout. FIG. 6a and FIG. 6b, depict side and top views, respectively, of a single pilot cockpit with rearward facing bench seat for passengers layout.

FIG. 7a, FIG. 7b and FIG. 7c, depict, respectively, perspective views of the structural geometry of the primary drive sections of the fuselage for four-cell, three-cell and two-cell vehicles.

FIG. 8a and FIG. 8b, depict top-half and side views, respectively, of the fuselage primary drive section and components for a two-cell vehicles which utilizes electrical, hydraulic or steam drive-motors on the drive-fans.

FIG. 9a and FIG. 9b, depict top-half and side views, respectively, of the fuselage primary drive section and components for a three-cell vehicles which utilizes electrical, hydraulic or steam drive-motors on the drive-fans.

FIG. 10a and FIG. 10b, depict top-half and side views, respectively, of the fuselage primary drive section and components for a four-cell vehicles which utilizes electrical, hydraulic or steam drive-motors on the drive-fans.

FIG. 11a, depicts a perspective view of the right wing assembly and structures and components adjacent to the fuselage for a two-cell vehicle. FIG. 11b, depicts a perspective bottom view of the left-half of the fuselage with wing assembly removed.

FIG. 12a and FIG. 12b, depict a view of the rear and front, respectively, of a three-cell vehicle with the right wing assembly in an actuated position.

FIG. 13a, depicts a side view of the fuselage section that connects with the wing assembly for a four-cell vehicle and the theoretical placements for wing assembly dihedral actuators. FIG. 13b and 13c, depict detailed front and side views, respectively, of a wing assembly dihedral actuator.

FIG. 13d, depicts a partial front view of a preferred embodiment of a vehicle utilizing the invention in relation to where components shown in FIG. 13b are located.

FIG. 14a, depicts a top skeletal view of the left wing assembly for a two-cell vehicle and its shroud venting arrangements and locations for control surface actuators.

FIG. 14b, depicts a side skeletal view of a wing assembly for a two-cell vehicle.

FIG. 14c, depicts a perspective view of a left wing assembly for a two-cell vehicle.

FIG. 15a, depicts a top skeletal view of the left wing assembly for a three-cell vehicle and its shroud venting arrangements and locations for control surface actuators.

FIG. 15b, depicts a side skeletal view of a wing assembly for a three-cell vehicle.

FIG. 15c, depicts a perspective view of a left wing assembly for a three-cell vehicle.

FIG. 16a, depicts a top skeletal view of the left wing assembly for a four-cell vehicle and its shroud venting arrangements and locations for control surface actuators.

FIG. 16b, depicts a side skeletal view of a wing assembly for a four-cell vehicle.

FIG. 16c, depicts a perspective view of a left wing assembly for a four-cell vehicle.

FIG. 17a, depicts a top view of the spacing of open cells for a fluid permeable panel constructed from a honeycomb core. FIG. 17b, depicts a side view of an enlarged area of a leading edge and structures that allow for curvature of faceted surfaces. FIG. 17c, depicts side views of the wing assembly sections, their dynamic laminar flow envelopes and possible modified curved structures as defined by the geometry of the invention.

FIGS. 18a through 18j, depict top skeletal views of possible wing assembly variations as defined by the geometry of the invention.

FIG. 19a, depicts a side view of a single drive motor, single drive-fan drive assembly. FIG. 19b, depicts a side view of a double drive motor, double drive-fan drive assembly. FIG. 19c depicts a top skeletal view of a four-cell vehicle in relation to drive motor placement.

FIG. 20, depicts computer central processing inputs and outputs for control, propulsion, and navigation.

### DETAILED DESCRIPTION OF THE INVENTION

As many components, structures and surfaces are identical in construction and function, for left and right sides of the vehicle, to reduce repetition and aid clarity to the drawings, components, structures and surfaces of only one side of the craft are labeled. Left and right side components, structures and surfaces shall be designated in the description, when necessary, with a suffix “-l,” designating left, or “-r,” designating right. For example 31a-l, shall designate the wing assembly surface/structure, 31a, on the left-hand side of the craft. The exception to this rule concerns only components, structures and surface which are centrally located on the fuselage, this exception includes: 1,4,10, 21a, 21b, 23, 25, 26, 27, 100, 104, 105, 106 and 190.

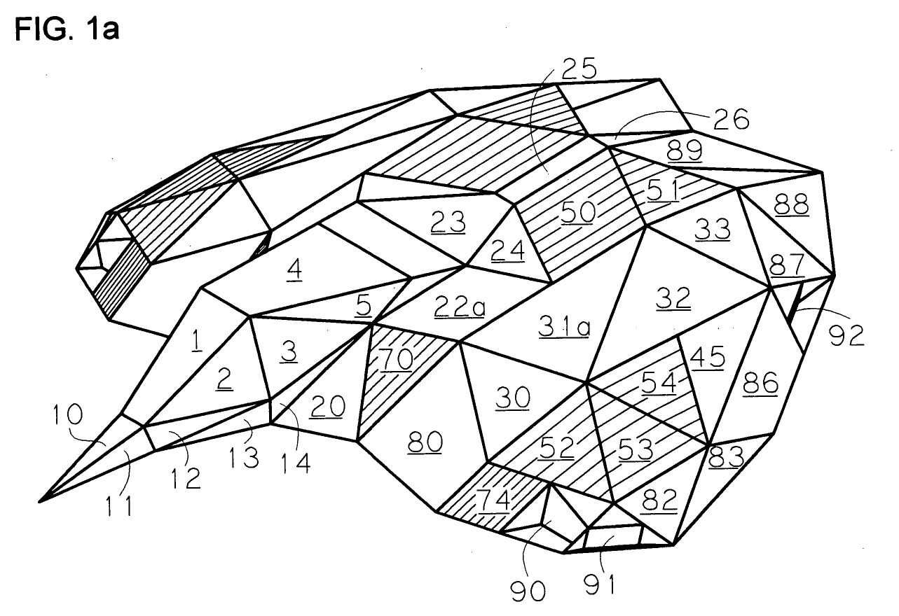

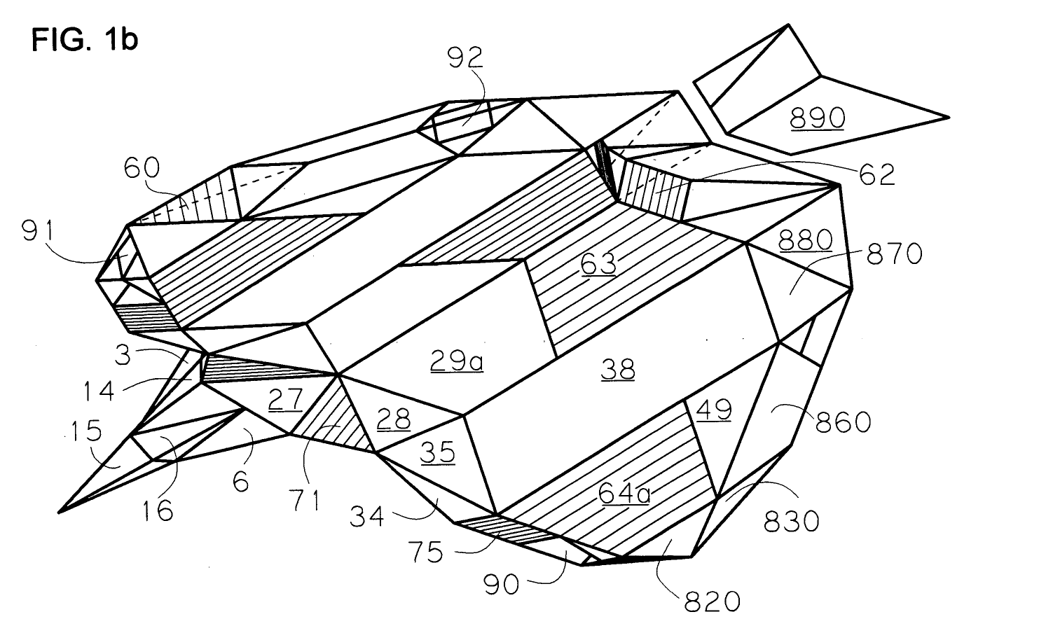

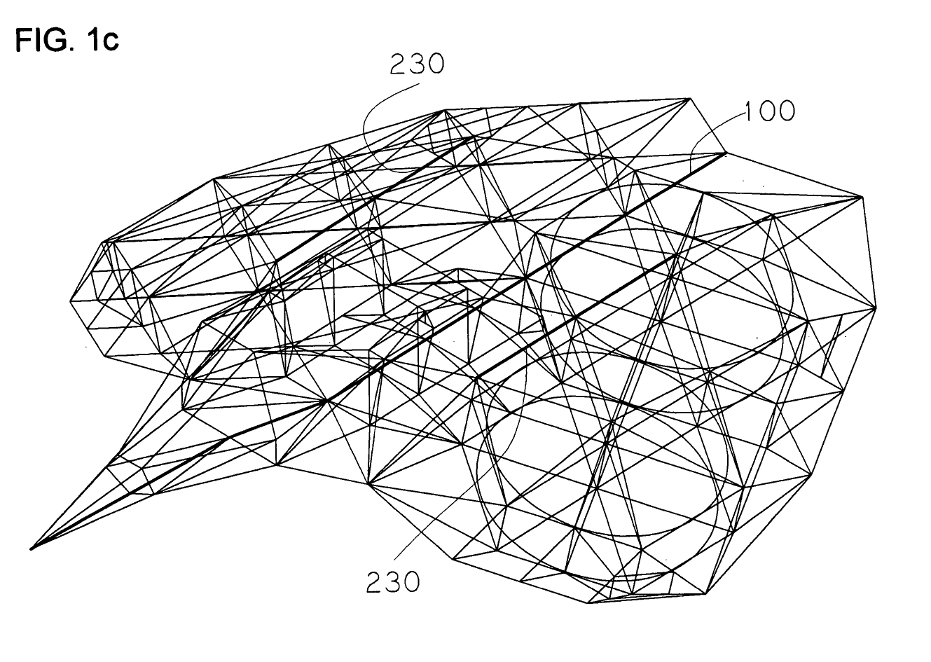

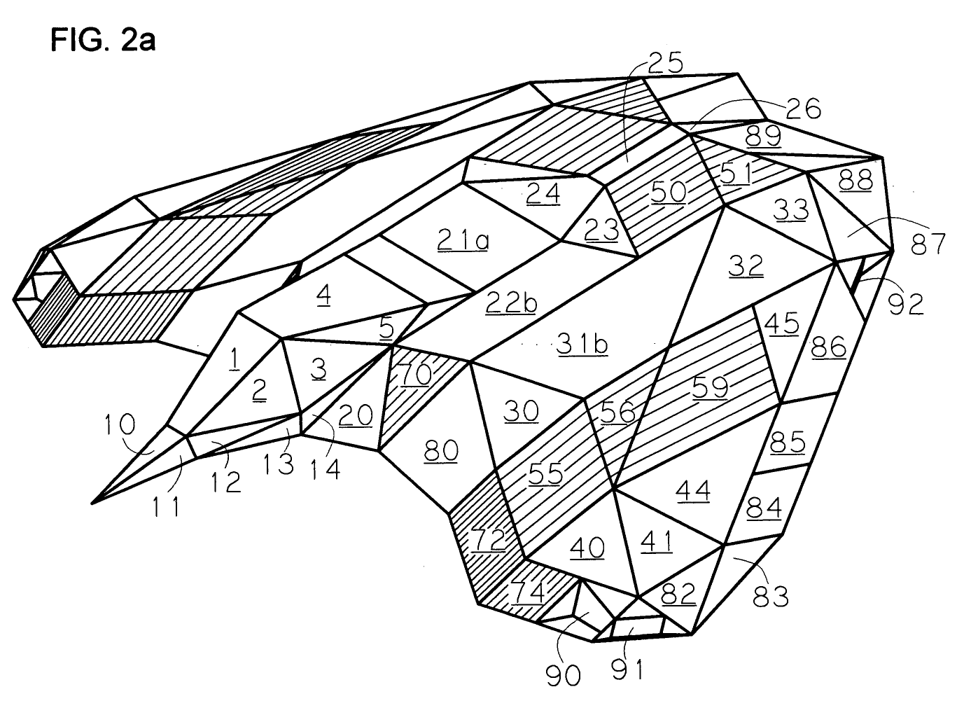

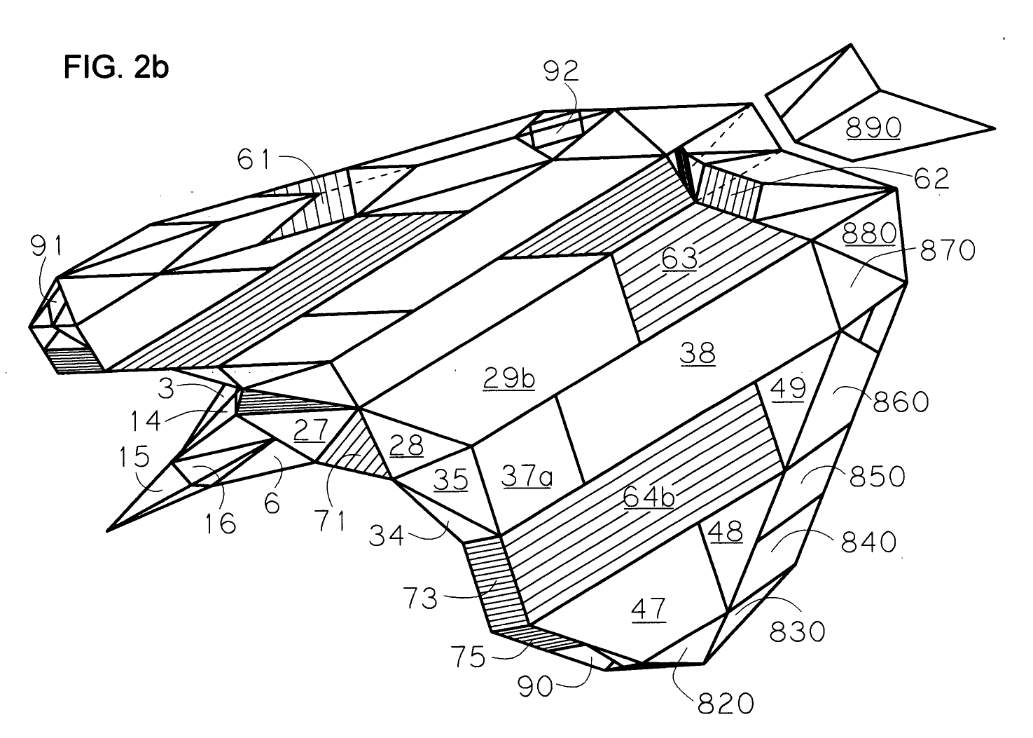

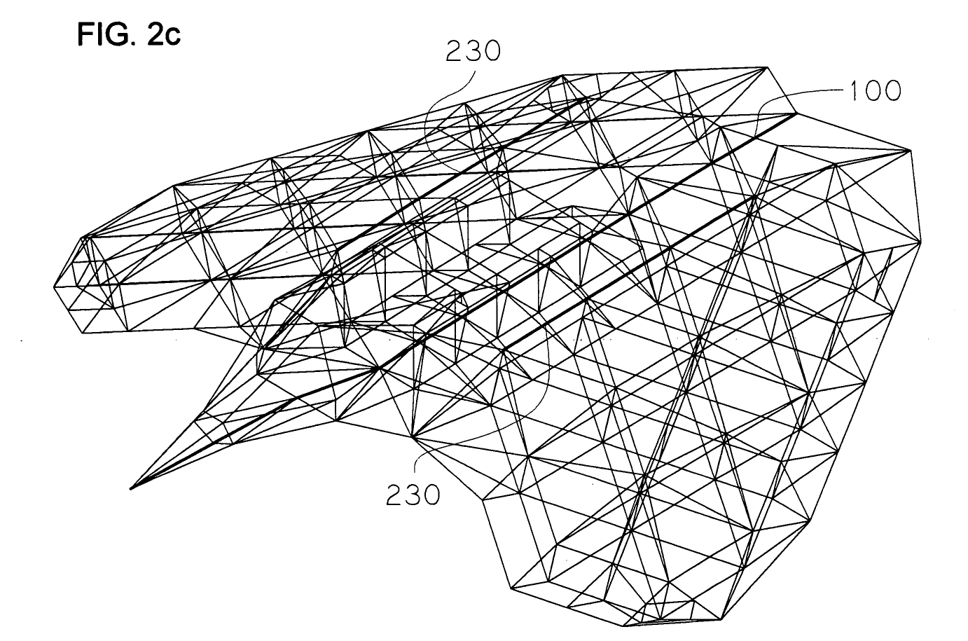

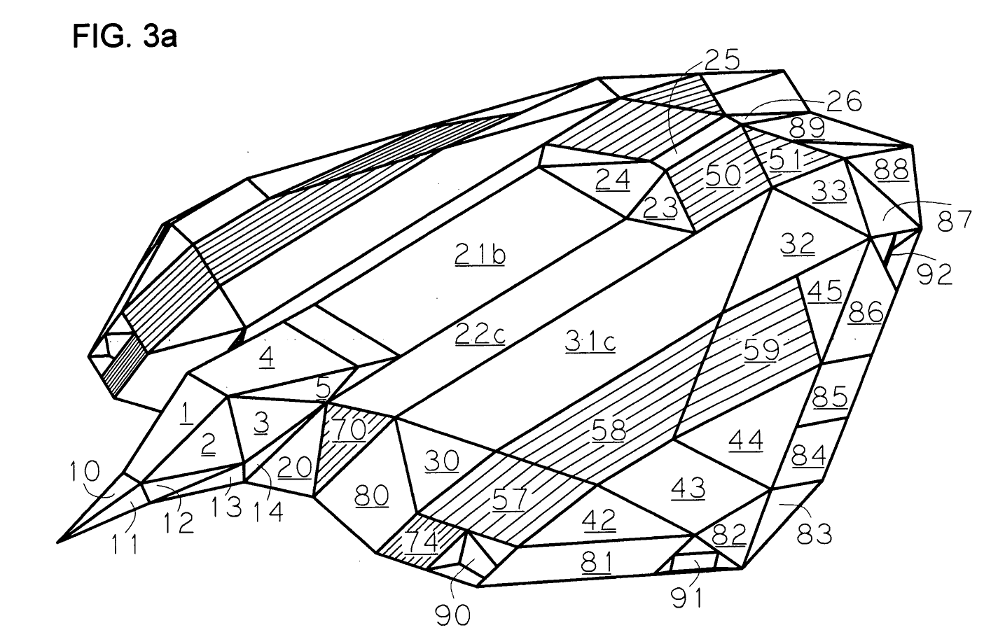

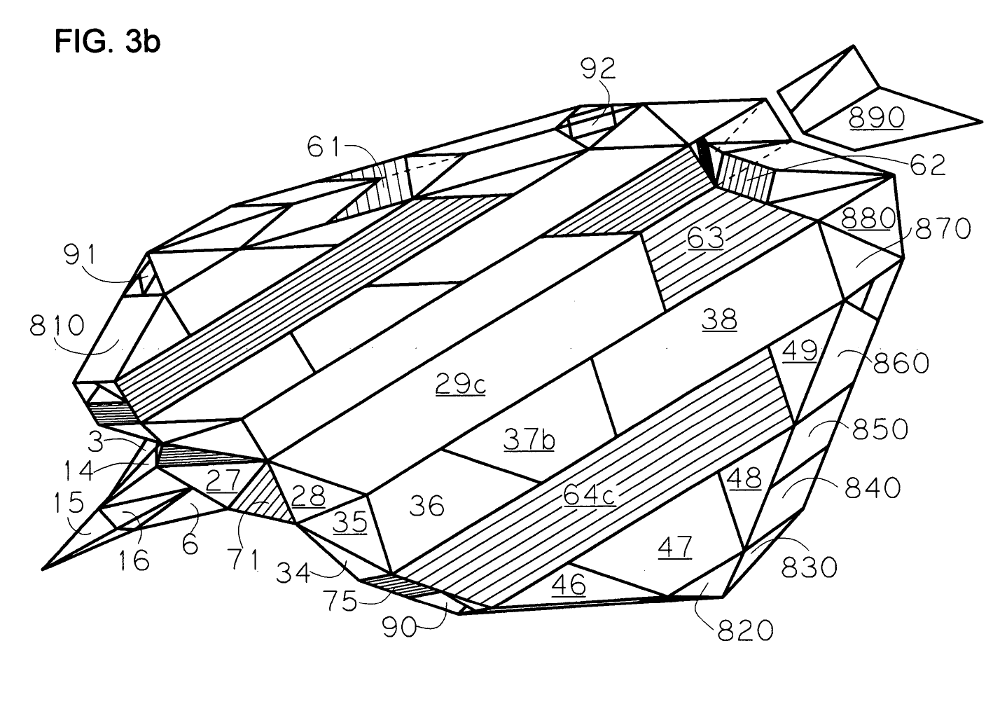

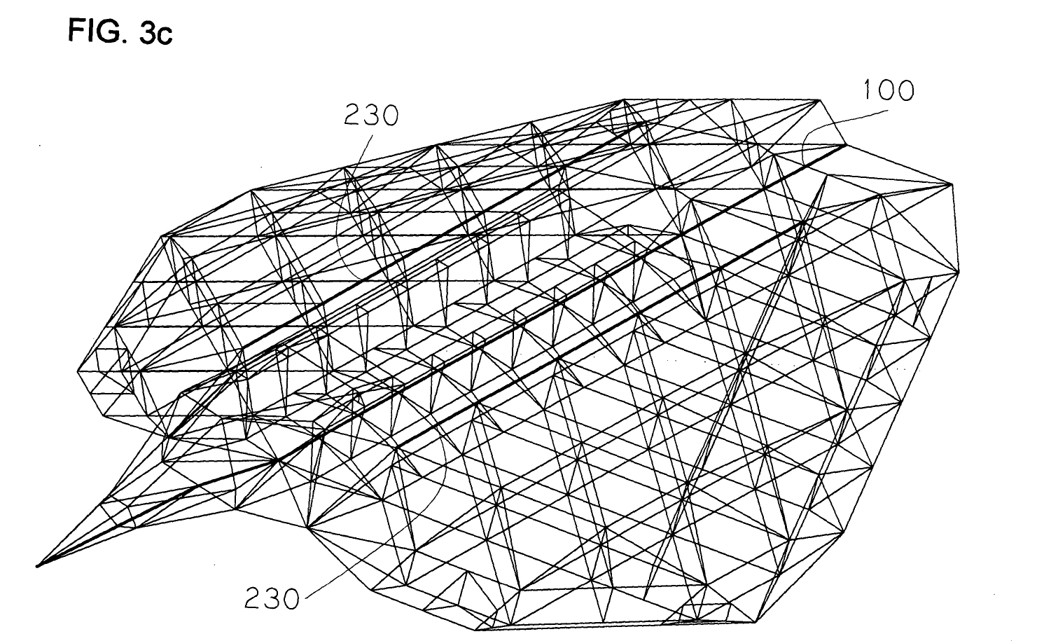

As many components, structures, and surfaces of two-cell, three-cell and four-cell vehicles which utilize the invention are nearly identical in construction and function, to reduce repetition, said components, structures and surfaces of the top perspective views as depicted in FIG. 1a (two-cell vehicle), FIG. 2a (three-cell vehicle) and FIG. 3a (four-cell vehicle) shall hereby be described in conjunction. If a component, structure or surface is described without a specific reference to a certain vehicle model, it shall be assumed that said element is common to all vehicles.

As shown, structures 10, 11-l and 11-r comprise the top of the nose-cone which serves the aerodynamic function of piercing the fluid medium and serves the additional function of housing airspeed sensors, infrared cameras, and in larger-scale craft radar components. These structures are non-permeable and serve no structural purpose beyond housing the above-mentioned components and acting as impact crumple zones.

Structures: 1, 2-l, 2-r, 3-l and 3-r comprise the front windscreen of the craft. These structures serve to protect the pilot/operator of the vehicle and may be made of plexi-glass, polycarbonate, auto-glass, ballistic glass or a combination of the above depending upon the role of the vehicle and weight constraints due to longitudinal center of gravity. A tubular framework, to which the above-mentioned transparent surfaces may be attached, may be employed for added strength and crash protection. These structures may also be double-paned to reduce drive-fan noise felt by the pilot/operator and passengers of the craft.

Structures: 12-l, 12-r, 13-l, 13-r, 14-l and 14-r are non-permeable structures which complete the top-forward of the cockpit section of the fuselage.

Structures: 4, 5-l, and 5-r comprise the canopy of the cockpit area of the craft. These structures may be of transparent materials like those utilized for the front windscreen or of opaque non-permeable construction. The canopy may be pivoted vertically upwards with the hinge-line either at the line separating structure 1 from 4 or the lateral line at the longitudinal aft of structure 4 to allow for entrance into the vehicle. These structures may also be double-paned to reduce drive-fan noise felt by the pilot/operator and passengers of the vehicle.

Surfaces 20-l and 20-r may be fixed non-permeable and sealed from the ambient fluid medium and may serve to partially house batteries, starter/alternator and hydraulic subsystems for control surfaces and wing assembly actuation. Surfaces 20-l and 20-r may also be of fixed semi-permeable construction to allow fluid flow into the drive section of the fuselage for increased heat transfer and primary drive cooling. This structure should be constructed strong enough to withstand the weight of the pilot/operator and/or any passenger as it also serves the function of a stepping point for entrance into the vehicle.

Surfaces 21a (three-cell vehicle), 21b (four-cell vehicle), 22a-l and 22a-r (two-cell vehicles), 22b-l and 22b-r (three-cell vehicles), 22c-l and 22c-r (four-cell vehicles), 23, 24-l and 24-r are of fixed semi-permeable construction to allow fluid flow, created by the suction of the drive-fans, into the drive section of the fuselage for increased heat transfer and primary drive cooling and which is then pulled into the drive-fan shrouds and controllably exhausted from the vehicle. The permeability of these structures is designed to create a laminar flow envelope over said structures. Surfaces 25 and 26 are non-permeable and may serve as mounting surfaces for a vertical stabilizer or t-tail.

Surfaces 70-l and 70-r are of fixed permeable or semi-permeable construction or of a controllable louvered type vane assembly and serves the function as fluid influx vent to the wing assembly when said wing assembly is in a closed, or non-actuated, position. The fluid inducted through these vents also passes over primary drive components, cooling said components. These structures are also designed to create a laminar flow envelope over said structures.

The above mentioned components, structures and surfaces comprise the fuselage elements of vehicles that utilize the invention that may be viewed from the top perspective.

In the following description of the components, structures and surfaces that comprise the wing assemblies of vehicles utilizing the invention, the suffixes “-l” and “-r” shall be dropped and it shall be assumed that one wing assembly is being described.

Surface 30, is located over the forward drive-fan for two-cell and four-cell vehicles and laterally adjacent and inboard to the forward fan of a three-cell vehicle, and may be of a non-permeable or semi-permeable construction and may also be pivoted vertically upwards from the wing assembly with the hinge-lines defined by the lines separating surface 30 from 31a or 30 from 52 (two-cell vehicle), 30 from 31b or 30 from 55 (three-cell vehicle) and 30 from 31c or 30 from 57 (four-cell vehicle), to increase fluid flow into the wing assembly and/or to serve the function of an air-brake.

Surfaces 31a (two-cell vehicle), 31b (three-cell vehicle) and 31c (four-cell vehicle) may be of non-permeable or semi-permeable construction and may be pivoted vertically upwards from the wing assembly along the hinge-lines defined by the lines separating surfaces 22a and 50 from 31a (two-cell vehicle), 22b and 50 from 31b (three-cell vehicle), and 22c and 50 from 31c (four-cell vehicle). The hinge-lines as just described also serve as hinge-lines for the entire wing assembly for each respective vehicle in which the wing assembly pivots from a negative or neutral dihedral to a more positive dihedral aspect. Surfaces 31a, 31b and 31c may also be rigidly connected with surface 32, which may be of a non-permeable or semi-permeable construction, and pivoted with surfaces 31 a, 31 b, and 31c along the hinge-lines defined above. 31a, 31b and 31c, either by themselves or when connected with surface 32 will be henceforth referred to as “top sub-wing.” The main function of the pivoting of the top sub-wing is to regulate fluid flow into the drive-fans as well as to affect roll and yaw control.

Surfaces 42 and 45 are of non-permeable construction and are the top surfaces of areas that may function as floatation or submersible ballast or fuel tanks. If used as fuel tanks, proper baffling should be employed to negate any rapid fluctuations in displacement of fuel created by movements of the vehicle or by wing assembly actuation.

Surfaces 33 and 80 (common to all vehicles), 40 and 41 (three-cell vehicle), 43 (four-cell vehicle) and 44 (common to three-cell and four-cell vehicles) may be of fixed, non-permeable or semi-permeable construction.

Surfaces 50 and 51 (common to all vehicles), 52, 53 and 54 (two-cell vehicles), 55 and 56 (three-cell vehicles), 57 and 58 (four-cell vehicles) and 59 (common to three-cell and four-cell vehicles) may be of fixed permeable or semi-permeable construction. The above-mentioned surfaces may also be of operable louvered vane design. The main function of these surfaces is to allow for fluid influx into the drive-fans from above while the vehicle is in forward motion. Said structures or their like are located only at the relative aft-ward rotation of the drive-fans so as to limit the turbulence created on the ambient fluid medium by the induction of fluid into the drive-fans.

Structures 72 (three-cell vehicles) and 74 (common to all vehicles) may be of fixed, permeable or semi-permeable construction or controllable louvered vanes, their main function is to provide fluid influx into the forward drive-fan shroud by the centrifugal suction of the forward drive-fan.

The permeability of the above-mentioned structures is designed to create a laminar flow envelope over said structures.

Surfaces 82, 83, 86, 87, 88 and 89 (common to all vehicles), 84 and 85 (common to three-cell and four-cell vehicles) and 81 (four-cell vehicle) are of non-permeable construction.

On four-cell vehicles, 81 may be fixed or pivoted vertically upward with the hinge-line being the common line dividing surface 42 from 81. In a pivoting configuration, 81 would serve as an air-brake.

Common to all vehicles, 82 may be fixed or pivoted vertically upward with the hinge-line being the common line dividing surface 53 from 82 (two-cell vehicles), 41 from 82 (three-cell vehicles) and 43 from 82 (four-cell vehicles). Common to all vehicles, a pivoting configuration of 82 may also serve an additional function of vectoring the centrifugal thrust created by the adjacent drive-fan.

Common to all vehicles, 83 may be pivoted vertically upward with the hinge-line being the common line dividing surface 82 from 83. On three-cell and four-cell vehicles, 83 may also be fixed. On all vehicles, the pivoting function of 83 serves the same function as a split-type aileron or flap. On two-cell vehicles, a pivoting configuration of 83 serves an additional function of vectoring the fluid exhaust from the forward drive-fan shroud created by the centrifugal thrust of the forward drive-fan.

On three-cell and four-cell vehicles, 84 and 85 may be independently pivoted vertically upward with the hinge-line being the common line dividing surface 44 from 84 and 44 from 85, respectively. On three-cell and four-cell vehicles, the independently pivoting functions of 84 and 85 serve the same function as split-type ailerons or flaps. On three-cell and four-cell vehicles, a pivoting configuration of 85 serves an additional function of vectoring the fluid exhaust from the adjacent drive-fan shroud created by the centrifugal thrust of the adjacent drive-fan.

Common to all vehicles, 86 may be pivoted vertically upward with the hinge-line being the common line dividing surface 45 from 86. Common to all vehicles, 87 may be pivoted vertically upward with the hinge-line being the common line dividing surface 33 from 87. Common to all vehicles, 88 may be pivoted vertically upward with the hinge-line being the common line dividing surface 87 from 88. 87 and 88 may also be linked to comprise one structure that may be pivoted vertically upward with the hinge-line being the common line dividing surface 33 from 87. Common to all vehicles, 89 may be pivoted vertically upward with the hinge-line being the common line dividing surface 51 from 89. On all vehicles, the pivoting functions of 86, 87, 88 and 89 serve the same functions as split-type ailerons or flaps.

Structures 90, 91 and 92 are, respectively, a head light/landing light fixture, a front marker/navigation/blinker light fixture and a rear marker/navigation/blinker/brake light fixture. These lighting fixtures are covered by transparent plexi-glass, polycarbonate, auto-glass or ballistic glass and conform to the lines of surrounding structures. Amphibious vehicle variants require these fixtures be waterproofed.

The above mentioned components, structures and surfaces comprise the wing assembly elements of vehicles that utilize the invention that may be viewed from the top perspective.

As many components, structures, and surfaces of two-cell, three-cell and four-cell vehicles which utilize the invention are nearly identical in construction and function, to reduce repetition, said components, structures and surfaces of the bottom perspective views as depicted in FIG. 1b (two-cell vehicle), FIG. 2b (three-cell vehicle) and FIG. 3b (four-cell vehicle) shall hereby be described in conjunction.

As shown, 15-l and 15-r comprise the bottom of the nose-cone which serves the aerodynamic function of piercing the fluid medium and serves the additional function of housing airspeed sensors, infrared cameras, and in larger-scale craft radar components. These structures are non-permeable and serve no structural purpose beyond housing the above-mentioned components and acting as impact crumple zones.

Structures: 6-l and 6-r may be transparent and therefore comprise viewing ports located upon the bottom of the craft. These structures may also be of non-permeable opaque construction.

Structures: 27, 16-l and 16-r are non-permeable structures which complete the bottom-forward of the cockpit section of the fuselage.

Surfaces 28-l and 28-r are of fixed, non-permeable construction and serve the purpose of housing batteries, starter/alternator and hydraulic subsystems for control surfaces and wing assembly actuation. Surfaces 28-l and 28-r may also be of fixed semi-permeable construction to allow fluid flow into the drive section of the fuselage for increased heat transfer and primary drive cooling.

Surfaces 29a-l and 29a-r (two-cell vehicles), 29b-l and 29b-r (three-cell vehicles), 29c-l and 29c-r (four-cell vehicles), are of fixed non-permeable construction and comprise the belly of the vehicle. The angular concavity of the belly of the vehicle is partially dependent upon the angle of the dihedral of the wing assemblies in a closed or non-actuated position, however, the belly may also be designed flat between the wing assemblies or even protruding vertically downward from the wing assemblies to accommodate increased fluid flow from vents 71-l and 71-r or to allow for increased cockpit/cabin area or to accommodate primary drive components.

Surfaces 71-l and 71-r are of fixed permeable or semi-permeable construction or of a controllable louvered type vane assembly and serve the function as fluid influx vent to the wing assembly, via triangular tunnel structures that run the length of the fuselage, when said wing assembly is in a closed, or non-actuated, position. The fluid inducted through this vent may also be directed to pass beneath primary drive components, cooling said components.

The above mentioned components, structures and surfaces comprise the fuselage elements of vehicles that utilize the invention that may be viewed from the bottom perspective.

In the following description of the components, structures and surfaces that comprise the wing assemblies of vehicles utilizing the invention, the suffixes “l” and “r,” shall be dropped and it shall be assumed that only one wing assembly is being described.

Surfaces 34 and 35 are of fixed non-permeable or semi-permeable construction and comprise the bottom inboard leading edge of the wing for all vehicles. Surfaces 48 (common to all vehicles), 37a (three-cell vehicles) and 37b (four-cell vehicles) are likewise of fixed non-permeable or semi-permeable construction.

Surface 36, is located over the inboard half of the forward drive-fan of four-cell vehicles and is of a non-permeable or semi-permeable construction and may also be pivoted vertically downwards from the wing assembly, along the hinge-line defined by the common line separating surface 36 from 64c, to increase fluid flow from the forward drive-fan.

Surface 38, is located over the inboard half of the second to aft drive-fan and the outboard half of the aft drive-fan for all vehicles and is of a non-permeable or semi-permeable construction and may also be pivoted vertically downwards from the wing assembly, along the hinge-line defined by the common line separating surface 38 from 64a, 64b or 64c, to increase fluid flow from said drive-fans.

Surfaces 46 and 49 are of non-permeable construction and are the bottom surfaces of areas that may function as floatation or submersible ballast or fuel tanks. If used as fuel tanks, proper baffling should be employed to negate any rapid fluctuations in displacement of fuel created by movements of the vehicle or by wing assembly actuation.

Surface 47, is located over the outboard half of the third to aft drive-fan for three-cell and four-cell vehicles and is of a non-permeable or semi-permeable construction and may also be pivoted vertically downwards from the wing assembly, along the hinge-line defined by the common line separating surface 47 from 64b or 64c, to increase fluid flow from said drive-fan.

Structures 60 (two-cell vehicles) and 61 (three-cell and four-cell vehicles) are the outboard wing assembly vents from which fluid thrust derived from the centrifugal thrust of the second to aft drive-fan is exhausted. Structure 62 (common to all vehicles) is the aft wing assembly vent from which fluid thrust derived from the centrifugal thrust of the aft drive-fan is exhausted.

Structures 63, 64a, 64b, and 64c may be of fixed permeable or semi-permeable construction. The above-mentioned surfaces may also be of operable louvered vane design. The main function of these surfaces is to allow for axial fluid exhaust from the drive-fans toward the bottom of the vehicle while the vehicle is in motion. Said structures or their like should be located only at the relative aft-ward rotation of the-drive fans so as to limit the negative turbulence created on the ambient fluid medium by the exhaust of fluid from the drive-fans.

Structures 73 (three-cell vehicles) and 75 (common to all vehicles) may be of fixed, permeable or semi-permeable construction or controllable louvered vanes, their main function to allow fluid influx into the forward drive-fan by the centrifugal suction of the forward drive-fan.

The permeability of the above-mentioned structures is designed to create a laminar flow envelope around said structures.

Surfaces 820, 830, 860, 870, 880 and 890 (common to all vehicles), 840 and 850 (common to three-cell and four-cell vehicles) and 810 (four-cell vehicle) are of non-permeable construction.

On four-cell vehicles, 810 may be fixed or pivoted vertically downward with the hinge-line being the common line dividing surface 46 from 810. In a pivoting configuration 810 would serve as an air-brake.

Common to all vehicles, 820 may be fixed or pivoted vertically upward with the hinge-line being the common line separating surface 64a from 820 (two-cell vehicles) and 47 from 820 (three-cell and four-cell vehicles), a pivoting configuration of 82 serves an additional function of vectoring fluid exhaust created by the centrifugal thrust of the inboard adjacent drive-fan.

Common to all vehicles, 830 may be pivoted vertically downward with the hinge-line being the common line separating surface 820 from 830. On three-cell and four-cell vehicles, 830 may also be fixed. On all vehicles, the pivoting function of 830 serves the same function as a split-type aileron or flap. On two-cell vehicles, a pivoting configuration of 830 serves an additional function of vectoring fluid exhaust created by the centrifugal thrust of the inboard adjacent drive-fan.

On three-cell and four-cell vehicles, 840 and 850 may be independently pivoted vertically downward with the hinge-line being the common line separating surface 48 from 840 and 48 from 850, respectively. On three-cell and four-cell vehicles, the independently pivoting functions of 840 and 850 serve the same function as split-type ailerons or flaps. On three-cell and four-cell vehicles, a pivoting configuration of 850 serves an additional function of vectoring fluid exhaust created by the centrifugal thrust of the inboard adjacent drive-fan.

Common to all vehicles, 860 may be pivoted vertically downward with the hinge-line being the common line separating surface 49 from 860. Common to all vehicles, 870 may be pivoted vertically downward with the hinge-line being the common line separating surface 38 from 870. Common to all vehicles, 880 may be pivoted vertically downward with the hinge-line being the common line separating surface 870 from 880. 870 and 880 may also be linked to comprise one structure that may be pivoted vertically upward with the hinge-line being the common line dividing surface 38 from 870. Common to all vehicles, 890 may be pivoted vertically downward with the hinge-line being the common line separating surface 63 from 890. On all vehicles, the pivoting functions of 860, 870, 880 and 890 serve the same functions as split-type ailerons or flaps.

The above mentioned components, structures and surfaces comprise the wing assembly elements of vehicles that utilize the invention that may be viewed from the bottom perspective.

As two-cell, three-cell and four-cell vehicles which utilize the invention rely upon a modular structural geometry in which many features are nearly identical, to reduce repetition, perspective views that show the structural geometry of said vehicles as depicted in FIG. 1c (two-cell vehicle), FIG. 2c (three-cell vehicle) and FIG. 3c (four-cell vehicle) shall hereby be described in conjunction. 100 designates the longitudinal centerline running along the bottom of the vehicles 230 designates the hinge-line for the wing assemblies.

Structures and components not specifically labeled in the above-mentioned drawings are not restrictive of the invention taken as a whole. The walls separating the cockpit/cabin from the primary drive sections of the fuselage should be insulated against the heat and sound derived from primary drive components. Structural elements that correspond with wing assembly installations and link wing assemblies across the fuselage should be engineered to withstand the thrust derived from the drive-fans and the gravitational forces that act upon the fuselage and wing assemblies under different loads corresponding to different speeds, movements and payload of the vehicle. V-like structures that longitudinally divide the cockpit/cabin from the primary drive sections and the aft drive-fan sections of the wing assemblies of the fuselage are used for routing of cockpit/cabin heating and cooling ducts, control conduits and also allow for designed differentiation of wing assembly dihedral when in a closed or non-actuated position. Triangular tunnels running the length of both sides of the bottom of the fuselage act as fluid channels to vents into the wing assembly shrouds and may also serve as primary drive engine exhaust mufflers. Where primary drive components are not subject to failure by exposure to the ambient fluid medium, they should be exposed to the fluid flow into the fuselage and to the wing assemblies to aid cooling.

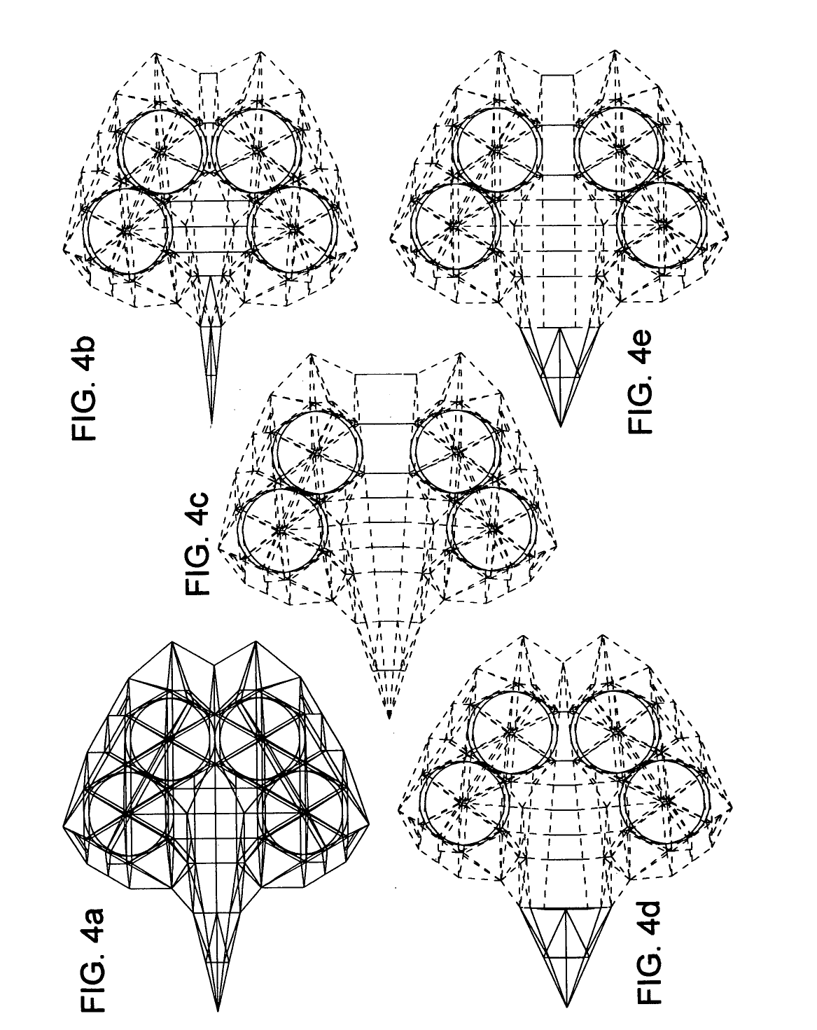

FIG. 4a, depicts the standard structural geometry of a two-cell vehicle when viewed from above. FIG. 4b, depicts the modified fuselage and wing assembly angle of a two-cell vehicle derived by the pivoting of the wing assemblies and fuselage halves inward from a point at where the aft drive-fans meet at the centerline of the aft of the main fuselage section. This modification will allow for a reduced width of cockpit/cabin area and a subsequent reduction in forward surface area, thereby decreasing the aerodynamic drag and lift of the vehicle. This modification will also cause the wing assemblies to pivot at an angle to the centerline of the vehicle during wing assembly actuation, instead of parallel to the vehicle as in the standard geometry, creating different aerodynamic characteristics of the wing assembly.

FIG. 4c, depicts the modified fuselage and wing assembly angle of a two-cell vehicle derived by the pivoting of the wing assemblies and fuselage halves outward from the tip of the nose of the vehicle. This modification will allow for an increased width of cockpit/cabin area and a subsequent addition in forward surface area, thereby increasing the aerodynamic drag and lift of the vehicle. This modification will also cause the wing assemblies to pivot at an angle to the centerline of the vehicle during wing assembly actuation, instead of parallel to the vehicle as in the standard geometry, creating different aerodynamic characteristics of the wing assembly. This modification will allow for the installation of auxiliary longitudinal propulsion components, for example a jet-turbine or turbines, mounted and exhausted between the aft drive-fans or the installation of split-type flaps located between the aft drive-fans.

FIG. 4d, depicts the modified fuselage and wing assembly angle of a two-cell vehicle derived by the pivoting of the wing assemblies and fuselage halves outward from the aft tip of the vehicle. This modification will allow for an increased width of cockpit/cabin area and a subsequent addition in forward surface area, thereby increasing the aerodynamic drag and lift of the vehicle. This modification will also cause the wing assemblies to pivot at an angle to the centerline of the vehicle during wing assembly actuation, instead of parallel to the vehicle as in the standard geometry, creating different aerodynamic characteristic of the wing assembly.

FIG. 4e, depicts the modified fuselage and wing assembly angle of a two-cell vehicle derived by splitting the fuselage halves and adding an equal width to the entire fuselage. This modification will allow for an increased width of cockpit/cabin area and a subsequent addition in forward surface area, thereby increasing the aerodynamic drag and lift of the vehicle. This modification will allow for the installation of auxiliary longitudinal propulsion, for example a jet-turbine or turbines, mounted and exhausted between the aft drive-fans or the installation of split-type flaps located between the aft drive-fans.

The above-mentioned modifications to the fuselage are not exclusive to two-cell vehicles but can also be designed into three-cell and four-cell vehicles with similar effects on fuselage area, installation of longitudinal propulsion and aerodynamic effects of the wing assemblies. It should be noted that these modifications will require the use or strengthened structural elements or modified lateral and longitudinal triangulation to compensate for the changes made to the standard structural geometry in the cases where the fuselage is made wider.

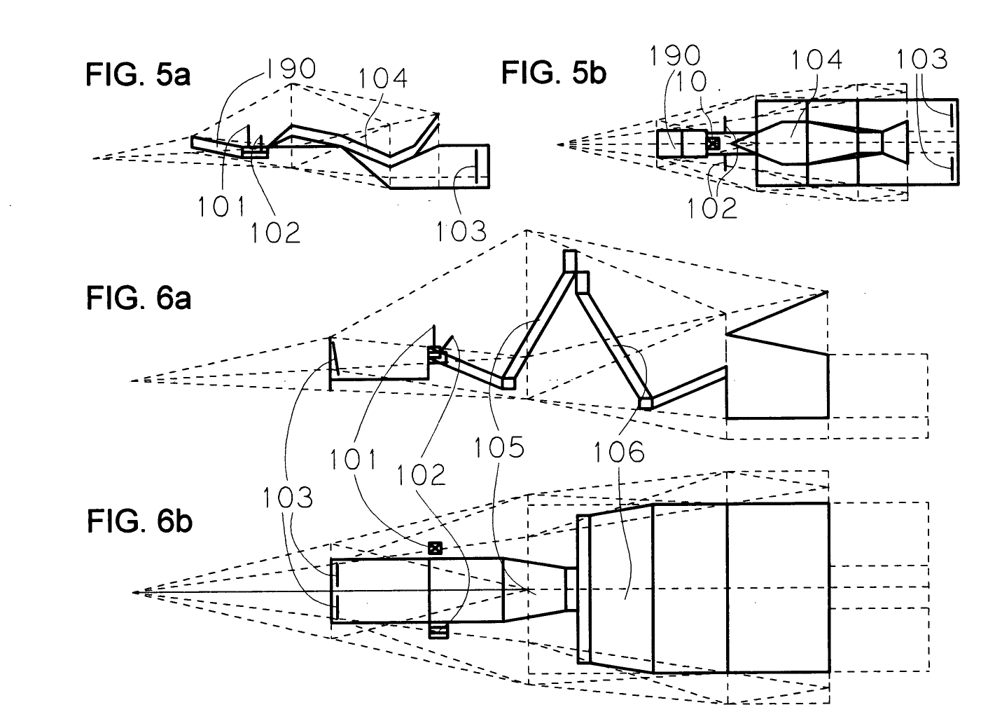

FIG. 5a and FIG. 5b, depict side and top views, respectively, of the cockpit area of relatively small-sized version of a vehicle utilizing the invention. The pilot/operator assumes a leaning forward, seated position very similar to that of one riding a high performance motorcycle. Multi-function display (MFD), 190, is arranged at the extreme forward of the cockpit and in the most natural position for constant monitoring. Joystick attitudinal control, 101, may be located either on the centerline of the vehicle and between the MFD and the cushioned forward area of the seat, 104, as depicted, or off-center, to one side of it's depicted location. Throttle and lift/longitudinal propulsion quadrants, 102, consisting of two levers, one for each function, may be located on both sides of the structure between the MFD, 190, and the forward area of the seat, 104, as depicted, or in the case of the attitudinal joystick, 101, being located off-center, 102 being located on the opposite side of the vehicle. Foot pedals, 103, are located to the aft of the cockpit, the right pedal effecting acceleration and the left pedal effecting braking, or vice versa.

FIG. 6a and FIG. 6b, depict side and top views, respectively, of the cockpit area of relatively medium-sized version of a vehicle utilizing the invention. The pilot/operator assumes a normal seated position in a seat, 105. Joystick attitudinal control, 101, as depicted, is on the right-hand side of 104, and the throttle and lift/longitudinal propulsion quadrant, 102, with the same functions as mentioned above, located to the left of 104. This arrangement is natural for a right-handed pilot/operator, however may be reversed for a left-handed pilot/operator. Foot pedals, 103, are located in forward section of the cockpit, the right pedal effecting acceleration and the left pedal effecting braking, or vice versa. 106, is an aft-ward facing bench seat for up to three passengers.

These FIGS. depict only two versions of cockpit/cabin arrangements based upon a standard structural geometry as examples of possible cockpit/cabin layouts. Larger vehicles or vehicles widened by a modified structural geometry may utilize different layouts.

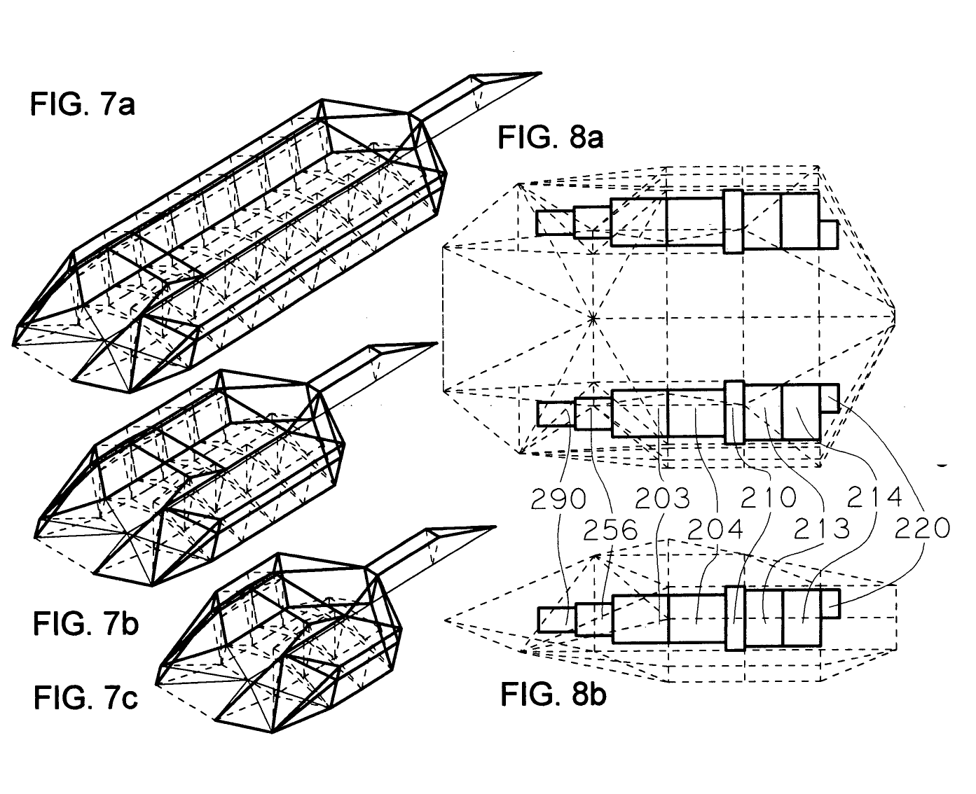

FIG. 7a, FIG. 7b and FIG. 7c, depict, respectively, perspective views of the structural geometry of the primary drive sections of the fuselage for four-cell, three-cell and two-cell vehicles which utilize electrical, hydraulic or steam drive-motors, the thicker solid lines representing top and side surface delineations, the thin solid lines depicting bottom surface delineations and the dashed lines depicting the internal structural geometry of said vehicles.

FIG. 8a and FIG. 8b, depict top-half and side views, r spectively, of the fus lage primary drive section and components for a two-c 11 craft. The primary drive unit of a two-cell vehicle utilizing electrical, hydraulic or steam drive-motors consists of: 290, which depicts an in-line starter/alternator (preferably 24 volt), 256, which depicts control and subsystems hydraulic pump (preferably a variable displacement swash-plate piston pump), 203, forward drive-fan electric generator, hydraulic pump (preferably a variable displacement swash-plate piston pump) or steam generator, 204, aft drive-fan electric generator, hydraulic pump (preferably a variable displacement swash-plate piston pump) or steam generator, 210, gear-reduction unit, 213, one-cylinder rotary internal combustion engine cell, 214, one-cylinder rotary internal combustion engine cell and 220, water-pump and oil pump installation position for unit cooling and lubrication, respectively.

It should be noted that although the previous and following descriptions of the primary drive sections of the fuselage depict the rotary internal combustion engine cells located to the aft of the vehicle and drive transmission components located to the fore of the vehicle, this arrangement may be reversed to effect longitudinal center of gravity. In short, the relative arrangement of internal combustion engine cells in regards to drive transmission components is dependent upon the weight of said elements in relation to the longitudinal center of gravity of the vehicle.

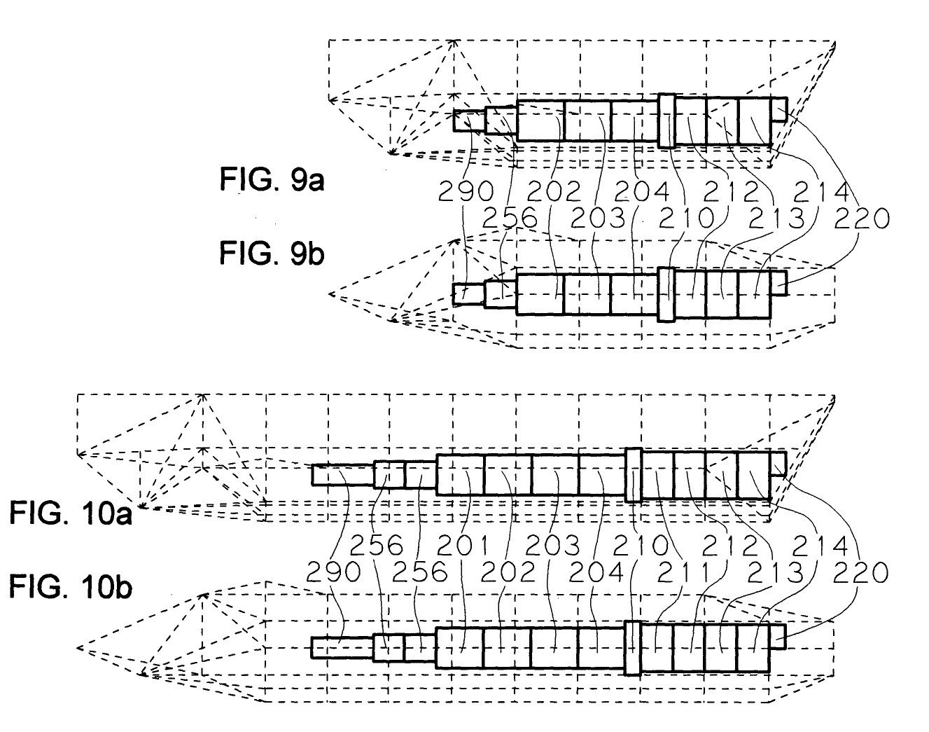

FIG. 9a and FIG. 9b, depict top-half and side views, respectively, of the fuselage primary drive section and components for a two-cell craft. The primary drive unit of a two-cell vehicle utilizing electrical, hydraulic or steam drive-motors consists of: 290, which depicts an in-line starter/alternator (preferably 24 volt), 256, which depicts control and subsystems hydraulic pump (preferably a variable displacement swash-plate piston pump), 202, forward drive-fan electric generator, hydraulic pump (preferably a variable displacement swash-plate piston pump) or steam generator, 203, middle drive-fan electric generator, hydraulic pump (preferably a variable displacement swash-plate piston pump) or steam generator, 204, aft drive-fan electric generator, hydraulic pump (preferably a variable displacement swash-plate piston pump) or steam generator, 210, gear-reduction unit, 212, one-cylinder rotary internal combustion engine cell, 213, one-cylinder rotary internal combustion engine cell, 214, one-cylinder rotary internal combustion engine cell and 220, water-pump and oil pump installation position for unit cooling and lubrication, respectively.

FIG. 10a and FIG. 10b, depict top-half and side views, respectively, of the fuselage primary drive section and components for a two-cell craft. The primary drive unit of a two-cell vehicle utilizing electrical, hydraulic or steam drive-motors consists of: 290, which depicts an in-line starter/alternator (preferably 24 volt), 256, which depicts control and subsystems hydraulic pump (preferably a variable displacement swash-plate piston pump), 201, forward drive-fan electric generator, hydraulic pump (preferably a variable displacement swash-plate piston pump) or steam generator, 202, forward drive-fan electric generator, hydraulic pump (preferably a variable displacement swash-plate piston pump) or steam generator, 203, middle drive-fan electric generator, hydraulic pump (preferably a variable displacement swash-plate piston pump) or steam generator, 204, aft drive-fan electric generator, hydraulic pump (preferably a variable displacement swash-plate piston pump) or steam generator, 210, gear-reduction unit, 211, one-cylinder rotary internal combustion engine cell, 212, one-cylinder rotary internal combustion engine cell, 213, one-cylinder rotary internal combustion engine cell, 214, one-cylinder rotary internal combustion engine cell and 220, water-pump and oil pump installation position for unit cooling and lubrication, respectively.

FIG. 8a and FIG. 8b, FIG. 9a and FIG. 9b and FIG. 10a and FIG. 10b when considered together, depict the modularity of primary drive systems of vehicles that utilize electric, hydraulic or steam motors to drive the drive-fans. By utilizing rotary internal combustion engines 211, 212, 213 and 214, cells may be added as drive-fans are added to comprise two-cell, three-cell and four-cell vehicles. The same is true by utilizing a cellular concept of drive generators, hydraulic or steam pumps, 201, 202, 203 and 204 and control pumps, 256. It should be noted that the utilization of hydraulic and steam pumps will have systems losses due to volumetric and mechanical efficiencies of less than 100%. The overall power input to the drive transmission from rotary engine cells should be configured to compensate for these efficiency losses as well as provide necessary power to drive control systems pumps and alternator/starter when in alternator mode.

The use of a supercharger(s) and/or turbo-charger(s) may compensate for a lack of horsepower from the rotary internal combustion cells, while adding little weight. Further more, an on-demand supercharger may be employed to be turned-on only during high power consumption instances, such as vertical take-off and landing or when accelerating longitudinally to aerodynamically sustained flight speed.

It should be noted hydraulic and steam drives will create more heat than an electrical drive, which will benefit the lifting characteristics of a given vehicle. Hydraulic and steam drives will also be preferable in amphibious variants of vehicles which utilize the invention. It should be noted that components for a hydraulic drive system are already available in many configurations from many manufacturers, however, a designed power unit of components already mentioned, utilizing a common drive shaft and common bearings and seals will reduce weight of the primary drive unit while also allowing for internal cooling. It should also be noted that advances in fuel cell technology may someday eliminate the need for internal combustion rotary engine cells and electrical generators, in a drive configuration that utilizes electrical drive motors on the drive-fans.

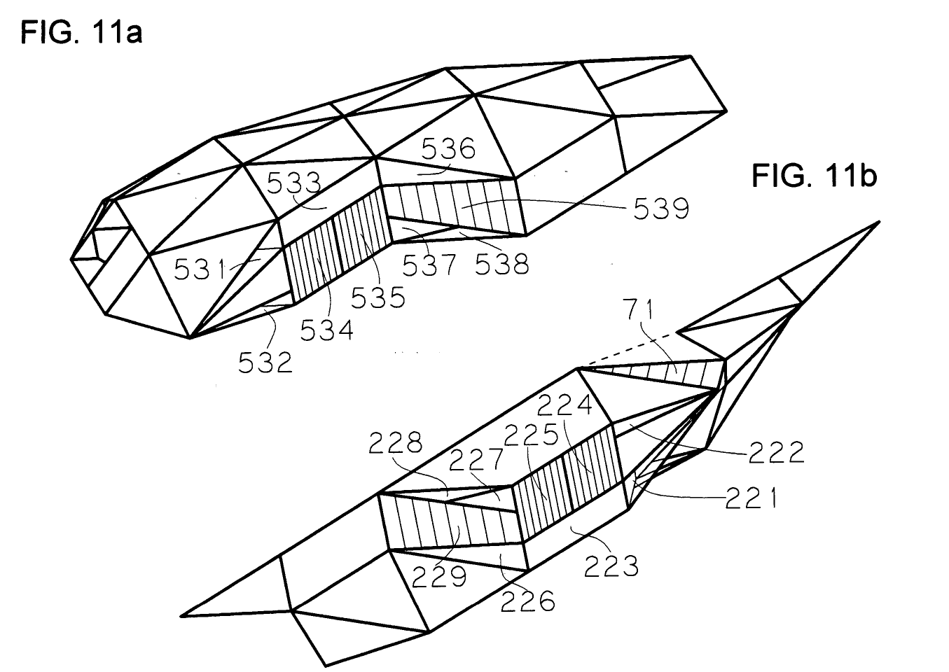

FIG. 11 a, depicts a perspective view of the right wing assembly and structures and components adjacent to where it connects with the fuselage for a two-cell craft 531, 533 and 536 depict open areas above the drive-fans and between the wing assemblies and fuselage that allow for fluid flow into the area above the adjacent drive-fans from vent 70 and other permeable and semi-permeable surfaces and structures on the adjacent fuselage when the wing assembly is in a closed, non-actuated, position, or allow for direct fluid flow into the area above the adjacent drive-fans when the wing assembly is an open, actuated, position. 533 will elongate longitudinally with the addition of drive-fan cells. 532, depicts an open area that allows for fluid flow into the shroud intake vent of the adjacent drive-fan. These structures should have mesh screens to prevent the ingestion of objects and debris that may damage the drive-fans or venting apparatuses when the wings are in an actuated position. 534, depicts a controllable vent that allows for fluid flow into the shroud intake vent of the adjacent drive-fan. 535, depicts a controllable vent that allows for fluid flow into and from the shroud vents of the adjacent drive-fan. Structures similar to 534 and 535 may be added longitudinally with additional drive-fan cells for three-cell and four cell vehicles. 537, 538 and 539 depict normally open vents that allow for fluid flow into and from the shroud vents of the adjacent drive-fan. These structures are normally open because during wing assembly actuation, these structures will be exposed to the ambient fluid medium and the ingestion of fluid by the aft drive-fan will offset the aerodynamic pitching motion created by the interaction of the these structures on the ambient fluid medium while in forward motion. These structures should have mesh screens to prevent the ingestion of objects and debris that may damage the drive-fans or venting apparatuses when the wings are in an actuated position.

FIG. 11 b, depicts a partial perspective bottom view of the fuselage and structures and components adjacent to where it connects with the wing assembly. 221, 223 and 236 depict open areas above the primary drive units and between the wing assemblies and fuselage that allow for fluid flow into the area above the adjacent drive-fans from vent 70 and other permeable and semi-permeable surfaces and structures on the fuselage when the wing assembly is in a closed, non-actuated. 223 will elongate longitudinally with the addition of drive-fan cells. 222, depicts the open area that links fluid flow from vent 71 with adjacent area 532. These structures should have mesh screens to prevent the ingestion of objects and debris that may damage the drive-fans or venting apparatuses when the wings are in an actuated position. 224, depicts a controllable vent or engine/drive-pump, radiator/condenser, that allows for fluid flow from the fuselage to the wing assembly intake vent, 534, of the adjacent drive-fan. 225, depicts a controllable vent or engine/drive-pump, radiator/condenser, that allows for fluid flow from the fuselage to the wing assembly intake vent, 535, of the adjacent drive-fan. Structures similar to 224 and 225 may be added with additional drive-fan cells. 227, 228 and 229 depict normally open vents that allows for fluid flow from the fuselage to the wing assembly intake vents, 537, 538, and 539, respectively, of the adjacent drive-fan. These structures should have mesh screens to prevent the ingestion of objects and debris that may damage the drive-fans or venting apparatuses when the wings are in an actuated position.

It should be noted that an accordion-type gasket may be employed at, and conforming to the shape of, the leading edge of the vehicle relatively between structures 531 and 532 and structures 221 and 222. This gasket would reduce the fluid flow into the above-mentioned intake vents when the wing assembly is in an open, or actuated, position while also reducing aerodynamic drag created by the exposed surfaces and structures under said actuation. It should also be noted that fluid flow into the area between the fuselage and wing assembly under actuation may be provided by the centrifugal thrust of the drive-fans through vents 534 and 535.

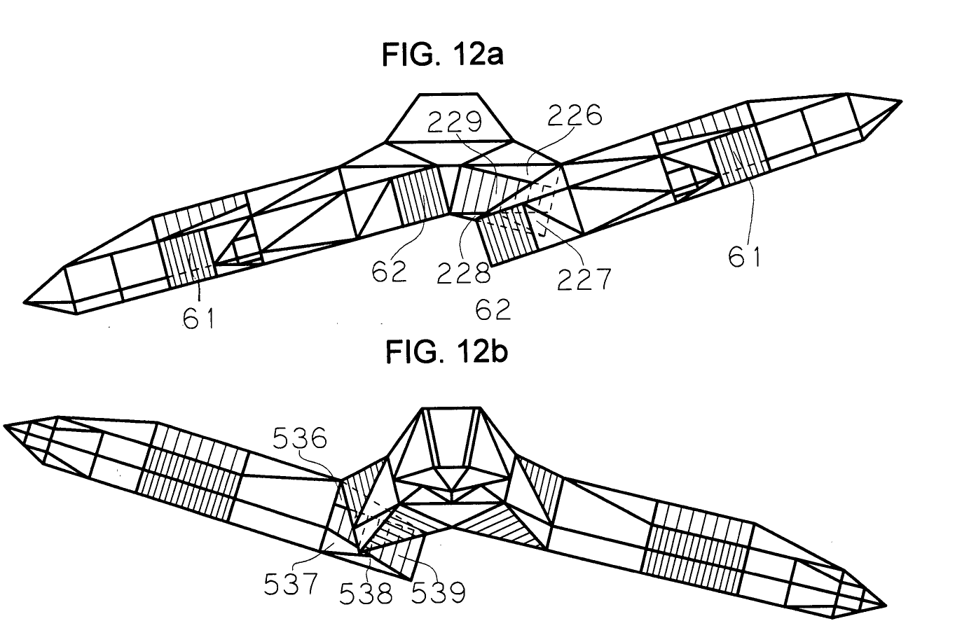

FIG. 12a and FIG. 12b, depict a view of the rear and front, respectively, of a three-cell vehicle and also show the placement of previously described components, structures and surfaces in regards to being viewed from the rear and front with the right wing assembly in an actuated position. Structures 85, 89, and 850 have been removed in order to view exhaust vents 61 and 62.

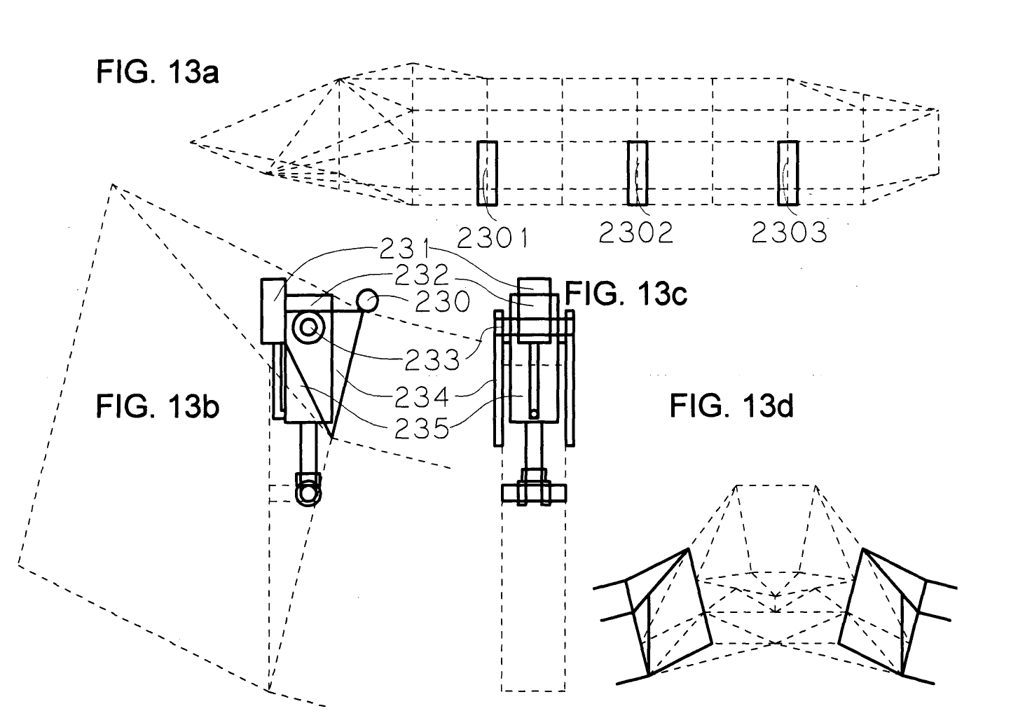

FIG. 13a, depicts a side view of the fuselage section that connects with the wing assembly for a four-cell craft and the theoretical placements for wing assembly dihedral actuators. 2303, is the position for a wing assembly actuator for a two-cell vehicle, 2303 and 2302 are the positions for wing assembly actuators for a three-cell vehicle and 2303, 2302 and 2301 are the positions for wing assembly actuators for a four-cell vehicle. FIG. 13b and 13c, depict detailed front and side views, respectively, of a wing assembly dihedral actuator. 231, depicts the hydraulic manifold for the hydraulic cylinder, 235. 232, depicts the preferred location of piston position sensor for the hydraulic cylinder, 235. 233, depicts the trunnion-mount for 235, attached to the wing assembly hinge bracket, 234. FIG. 13d, depicts a partial front view of a preferred embodiment of a vehicle utilizing the invention in relation to where components shown in FIG. 13b are laterally located in regards to the fuselage. As most hydraulic cylinders have a much greater push force than pull and greater force will be required to close the wing due to the thrust of the drive-fans and aerodynamic lift of the wing assemblies, this actuation arrangement is preferred, however other arrangements are possible. Hydraulic cylinders should have enough thrust to overcome the thrust of the drive-fans and gravitational and aerodynamic forces.

The actuation of the dihedral of the wing assemblies provides control of yaw, roll and pitch movements, lateral center of gravity and fluid flow to and from each respective drive-fan shroud and between left and right wing assemblies. The wing assemblies are hinged to the fuselage by a piano-type hinge and pin assembly, running the length of line 230 as depicted in FIG. 1c, FIG. 2c and FIG. 3c, that is designed to withstand the maximum thrust of the wing assembly drive-fans and the forces acted upon the wing assembly under different movements at maximum speed and lift. By utilizing quick release couplings for drive lines, control lines and subsystem electrical and hydraulics to the wing assemblies in conjunction with removing the pins from the wing assemblies hinges, the vehicle can be quickly disassembled for transport.

It should be noted that attention must be paid toward the interaction of the structure housing the aft drive-fan and the ambient fluid medium as that portion of the wing assembly enters the fluid medium stream under longitudinal forward motion to prevent rapid pitching movements to the vehicle. It should also be noted that although all drawings depict vehicles with a wing assembly dihedral of negative aspect and in which the wing assemblies pivot upwards, th geometry of the invention also allows for wing assemblies to be of a positive aspect and pivot downwards or of a neutral aspect and pivot up or down.

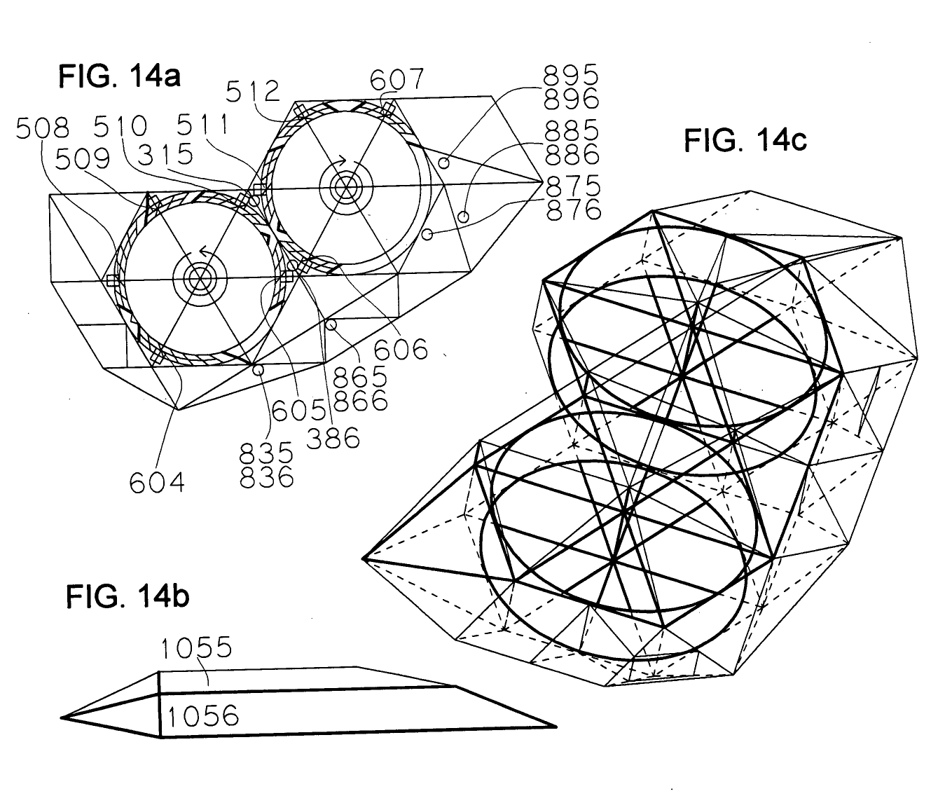

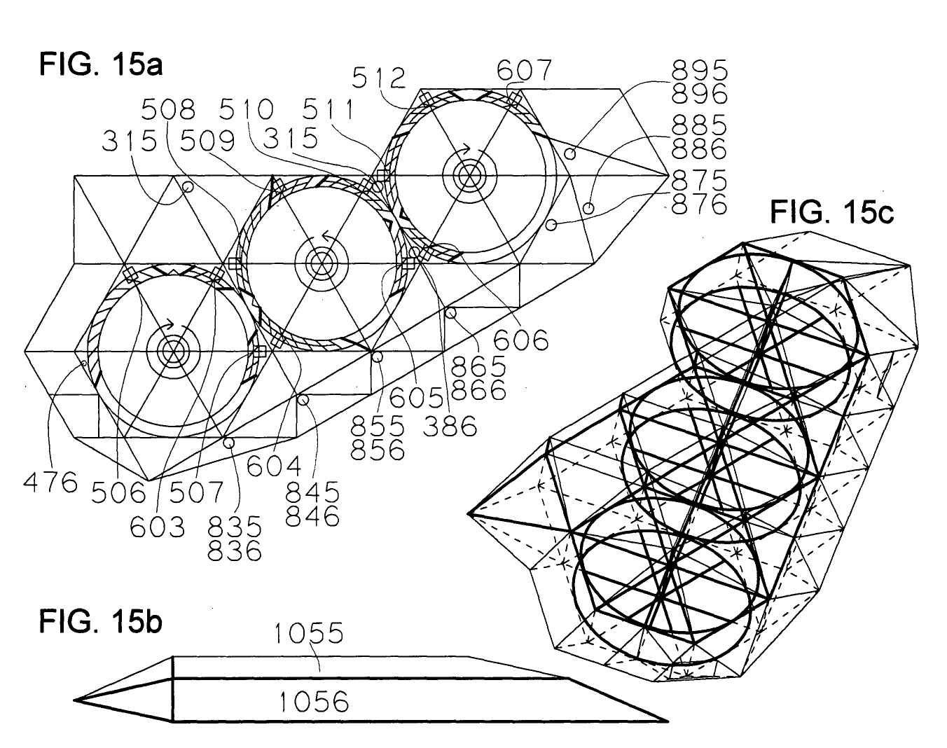

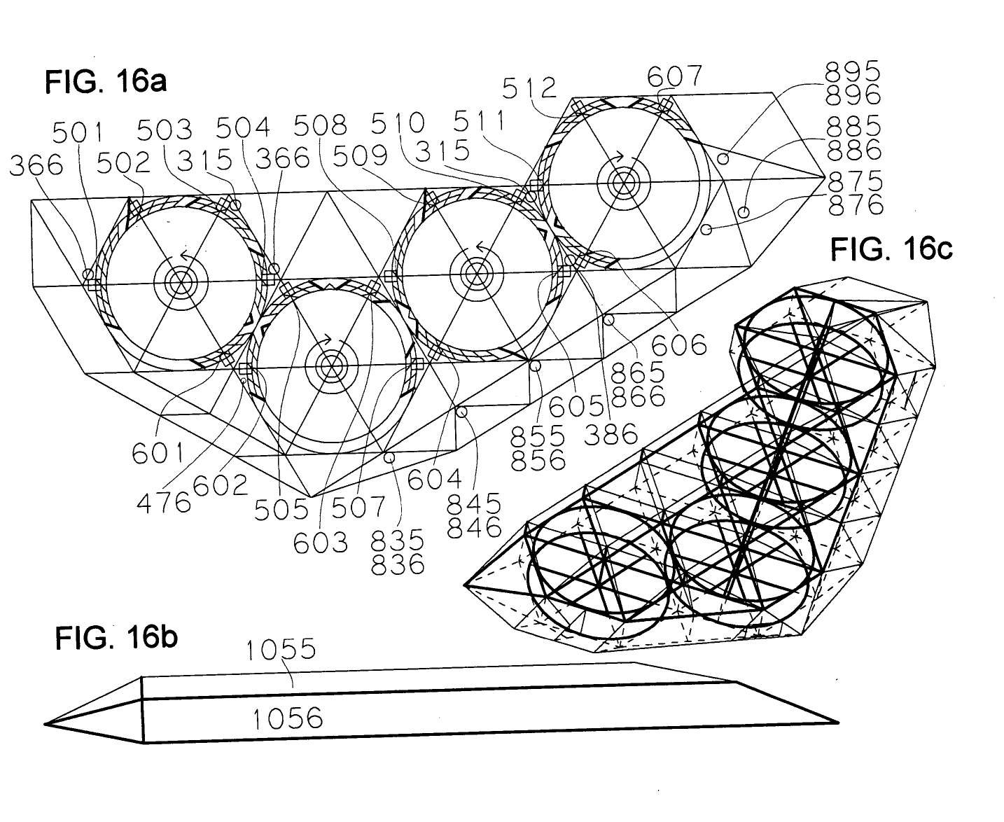

As many components, structures, and surfaces of the wing assemblies for two-cell, three-cell and four-cell vehicles which utilize the invention are nearly identical in construction and function, to reduce repetition, said components, structures and surfaces of the top views as depicted in FIG. 14a, FIG. 14b and FIG. 14c (two-cell vehicle), FIG. 15a, FIG. 15b and FIG. 15c (three-cell vehicle) and FIG. 16a, FIG. 16b, and FIG. 16c (four-cell vehicle) shall hereby be described in conjunction. If a component, structure or surface is described without a specific reference to a certain vehicle model, it shall be assumed that said element is common to all vehicles. It should be noted that 500 series numbers designate intake vents, 600 series numbers designate exhaust vents, 800 series numbers ending in 5, example 835, designate control surface actuators that act upon top control surfaces and 800 series numbers ending in 6, example 836, designate control surface actuators that act upon bottom control surfaces.

It should be noted that the placement of actuators for 500 and 600 series shroud vents are depicted by rectangles in parallel with lines bisecting the hexagonal cell structure surrounding the drive-fan shrouds.

508, depicts an operable intake vent which draws fluid by the centrifugal suction of the second to aft drive-fan from area 532 (two-cell vehicle) and/or from structures similar to 534 and 535 and from exhaust vent 603 (three-cell and four-cell vehicles) into the immediately adjacent drive-fan shroud when the wing assembly is in a closed position or from the ambient fluid medium when in an actuated position. 509, depicts an operable intake vent which draws fluid by the centrifugal suction of the second to aft drive-fan from structure 534 into the immediately adjacent drive-fan shroud when the wing assembly is in a closed position or from the ambient fluid medium when in an actuated position. 510, depicts an operable intake vent which draws fluid by the centrifugal suction of the second to aft drive-fan from area 535 into the immediately adjacent drive-fan shroud when the wing assembly is in a closed position or from the ambient fluid medium when in an actuated position or from exhaust vent 606. 511, depicts an operable intake vent which draws fluid by the centrifugal suction of aft drive-fan from partial areas of 537, 538 and 539 or from exhaust vent 605 into the immediately adjacent drive-fan shroud when the wing assembly is in a closed position or from the ambient fluid medium when in an actuated position. 512, depicts an operable intake vent which draws fluid by the centrifugal suction of aft drive-fan from partial areas of 537, 538 and 539 into the immediately adjacent drive-fan shroud when the wing assembly is a closed position or from the ambient fluid medium when in an actuated position.

604, depicts an operable exhaust vent which exhausts fluid from the second to aft drive-fan shroud and subsequently the wing assembly by the centrifugal thrust of the second to aft drive-fan. 605, depicts an operable exhaust vent which exhausts fluid from the immediately adjacent drive-fan shroud by the centrifugal thrust of the second to aft drive-fan into a fluid channel between the second to aft and aft drive-fan shrouds. 606, depicts an operable exhaust vent which exhausts fluid from the immediately adjacent drive-fan shroud by the centrifugal thrust of the aft drive-fan into a fluid channel between the second to aft and aft drive-fan shrouds. 607, depicts an operable exhaust vent which exhausts fluid from the aft drive-fan shroud and subsequently the wing assembly by the centrifugal thrust of the aft drive-fan. These vents are common to all vehicles and comprise the total shroud venting means for a two-cell vehicle.

315, is an actuator, hydraulic or electrical, for structure 31a, 31b or 31c. 386, is an actuator, hydraulic or electrical, for structure 38. 835 and 836 are actuators, hydraulic or electrical, for structures 83 and 830, respectively. 865 and 866 are actuators, hydraulic or electrical, for structures 86 and 860, respectively. 875 and 876 are actuators, hydraulic or electrical, for structures 87 and 870, respectively. 885 and 886 are actuators, hydraulic or electrical, for structures 88 and 880, respectively. 895 and 896 are actuators, hydraulic or electrical, for structures 89 and 890, respectively. These actuators are common to all vehicles and comprise the total control surface actuator means for a two-cell vehicle.

For a three-cell vehicle, 507, depicts an operable intake vent which draws fluid by the centrifugal suction of the third to aft drive-fan from vent 604 into the immediately adjacent drive-fan shroud. 506, depicts an operable intake vent which draws fluid by the centrifugal suction of the third to aft drive-fan from vents 72, 73, 74 and 75 into the immediately adjacent drive-fan shroud. 603, depicts an operable exhaust vent which exhausts fluid from the immediately adjacent drive-fan shroud by the centrifugal thrust of the third to aft drive-fan into a fluid channel between the third to aft and second to aft drive-fan shrouds. These vents are common to three-cell and four-cell vehicles, with the exception of vent 506.

476, is an actuator, hydraulic or electrical, for structure 47. 845 and 846 are actuators, hydraulic or electrical, for structures 84 and 840, respectively. 855 and 856 are actuators, hydraulic or electrical, for structures 85 and 850, respectively. These actuators are common to three-cell and four-cell vehicles.

For a four-cell vehicle, 501, depicts an operable intake vent which draws fluid by the centrifugal suction of the forward drive-fan from area 532 into the immediately adjacent drive-fan shroud when the wing assembly is in a closed position or from the ambient fluid medium when in an actuated position. 502 and 503 depict operable intake vents which draw fluid by the centrifugal suction of the forward drive-fan from structures similar to 534 and 535 into the immediately adjacent drive-fan shroud when the wing assembly is in a closed position or from the ambient fluid medium when in an actuated position. 506 (found on a three-cell vehicle) is partially replaced by 505 which depicts an operable intake vent which draws fluid by the centrifugal suction of the third to aft drive-fan from operable exhaust vent 601 into the immediately adjacent drive-fan shroud. 602, depicts an operable exhaust vent which exhausts fluid from the immediately adjacent drive-fan shroud by the centrifugal thrust of the forward drive-fan into a fluid channel between the forward and third to aft drive-fan shrouds.

To summarize the function of the shroud venting apparatuses: vents located between adjacent drive-fans are used to regulate fluid flow between said drive-fans by the relative centrifugal thrust and suction of said drive-fans, wherever possible intake vents are installed to take advantage of centrifugal fluid flow into the drive-fans from surrounding structures and surfaces while creating a laminar flow envelope around said elements and exhaust vents are installed where the centrifugal thrust derived from aft-ward rotation of the drive-fans may be vented so as exhaust fluid created by the centrifugal thrust of the drive-fans will create longitudinal thrust.

366, is an actuator, hydraulic or electrical, for structure 37. These actuators are common to four-cell vehicles.

FIG. 14b, FIG. 15b and FIG. 16b depict, respectively, side skeletal views of the wing assemblies for two-cell, three-cell and four-cell vehicles. 1055, depicts the vertical area above the drive-fan shrouds, which serve to cover the upper part of the drive motors and drive lines while allowing for fluid flow from the fuselage into the drive-fans and while also creating the aerodynamic shape of the wing. 1056, depicts the vertical area housing the drive-fans, this area need only be as deep as necessary to house the drive-fans with regards to clearance of drive-motor and pitch actuation mounting supports during different movements of pitch actuation in conjunction with wing assembly and drive-fan blade flexing.

FIG. 14c, FIG. 15c and FIG. 16c depict a perspective view of a left wing assembly for a two-cell craft, three-cell craft and four-cell craft, respectively. The thick solid lines depict the top drive-fan section of the wing assemblies and intersecting construction lines for the centers for mounting the drive-fans and drive-means to the drive-fans. The thin solid lines depict the top and outer edges of the wing assemblies. The dashed lines depict the interior structural lines that complete the structural geometry of the wing assemblies. It should be noted that the dark lines that depict the bisecting lines of the hexagonal cells that enclose the drive-fan shrouds also form at their intersections the centers for the mounting of drive-fan components.

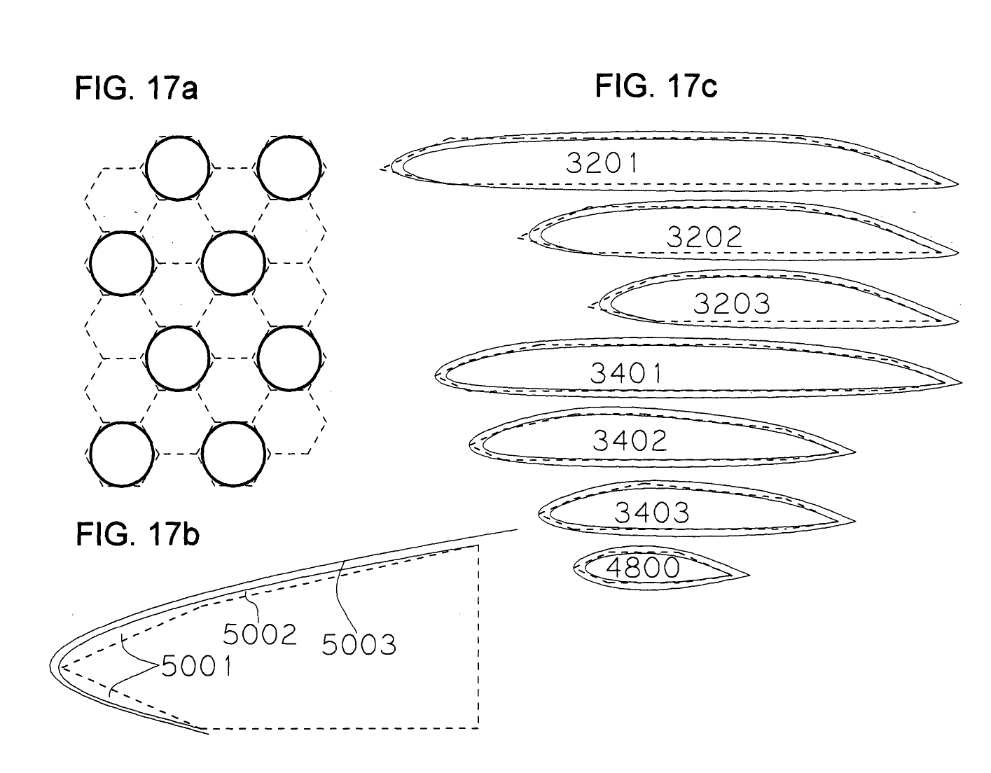

FIG. 17a, depicts a top view of the spacing of open cells for a fluid permeable panel constructed from a honeycomb core. The open cells, depicted by thick-lined circles, are spaced such as to maintain the structural integrity of the semi-permeable honeycomb structure, depicted by dashed lines. The honeycomb structure may be of metal or composite construction and rigidity to said structures may be increased by filling cells not open to fluid flow with rigid foam and then bonding composite or metal skin to the foam-filled panel while leaving cells open to fluid flow uncovered or drilled-out. This arrangement of open and closed cells is meant to depict the maximum number of open cells to closed cells to maintain the structural integrity of the panel and that open cells as depicted may be also filled-in to increase structural integrity or to increase laminar flow characteristics over said panel.

FIG. 17b, depicts a side view of an enlarged area of a leading edge and structures that allow for curvature of flat faceted surfaces. The dashed line structure is the faceted surfaces as depicted in previous FIGS. 5001 is a sculpted foam layer between the faceted surface and a top layer or layers, 5002 and 5003, of fiberglass, graphite or aramid fabric and to which the sculpted foam layer is bonded, by compatible resins, to both the faceted surface and the top layers.

The final chord curvature of the wing assembly may be derived by first analyzing different variants of curvature by computational fluid dynamics (CFD) computer programming then constructing different foam panels to temporarily affix to the faceted surfaces during wind tunnel testing. Curvature may also be achieved in a tube frame by designed bending of the tubing after CFD analysis and wind tunnel testing have resolved the question of best aerodynamic shape of the wing assemblies for given role and performance parameters.

FIG. 17c, depicts side views, cross-sectional views, of the wing assembly sections, depicted by dashed-lines, their dynamic laminar flow envelopes, depicted by solid thin lines exterior of the dashed-lines, and possible modified curved structures, depicted by thin solid lines interior of the dashed-lines, as defined by the geometry of the invention. 3201, 3202 and 3203 depict the sectional view of the wing assembly that is directly adjacent to the fuselage and longitudinally bisects the aft drive-fan for four-cell, three-cell and two-cell vehicle, respectively. 3401, 3402 and 3403 depict the sectional view of the wing assembly that longitudinally bisects the second to aft drive-fan for four-cell, three-cell and two-cell vehicle, respectively. 3402 and 3403 also depict the sectional view of the wing assembly that longitudinally bisects the third to aft drive-fan for four-cell and three-cell vehicles, respectively. 4800, depicts the sectional view of the wing assembly that is directly adjacent to the outboard drive-fan for all vehicles.

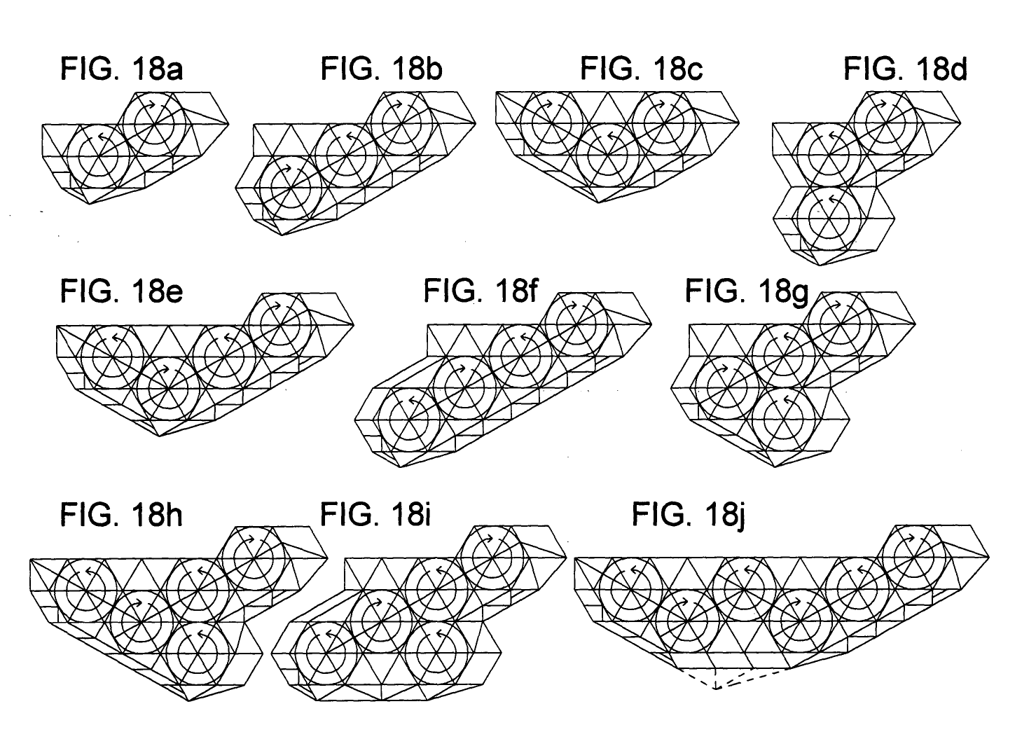

FIGS. 18a through FIG. 18j, depict top skeletal views of possible wing assembly variations as defined by the geometry of the invention. As shown the structural geometry of the invention allows for a wide range of wing assembly shapes and number of drive-fans. In designing and constructing said wings it should be noted that certain afore-mentioned characteristics of two-cell, three-cell and four-cell wing assemblies should be retained: that drive-fans are exposed only at their relative aft-ward rotation, that shroud venting means take advantage of inducting fluid where ever possible, that vents between longitudinally adjacent drive-fans be designed to regulate fluid flow between said drive-fans and that where ever possible exhaust vents are installed where the aft-ward rotation of relative drive-fans may be vented from the vehicle to create longitudinal propulsion. It should be noted that laterally adjacent drive-fans will share no venting means between said drive-fans.

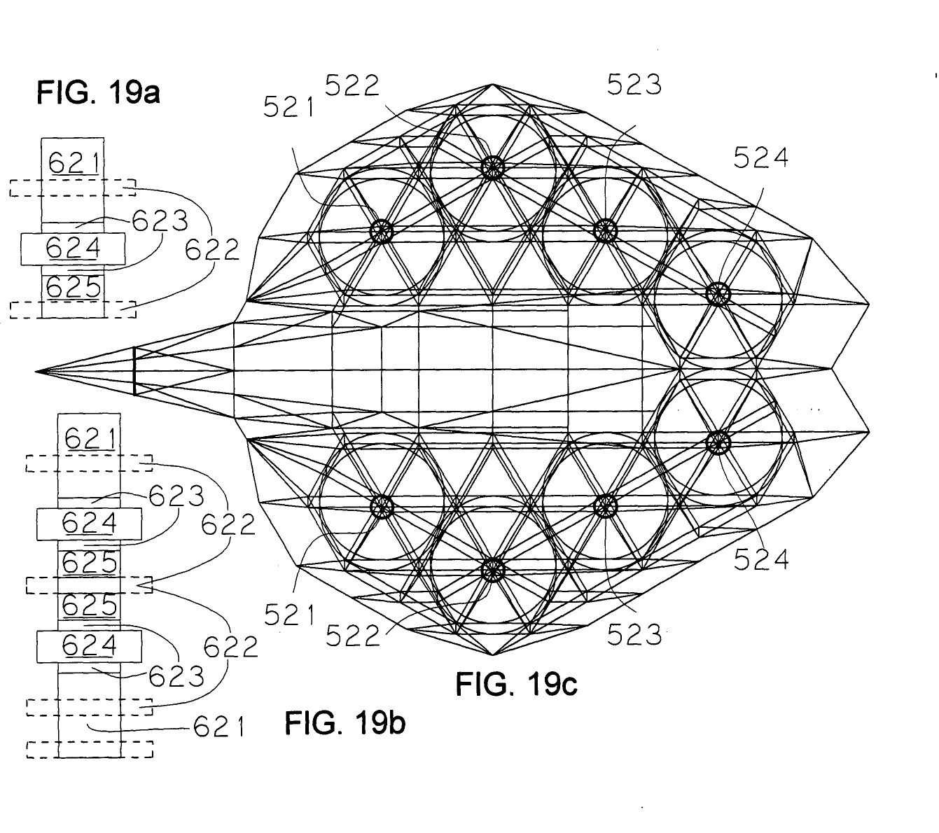

FIG. 19a, depicts a side view of a single drive-motor, 621, single drive-fan drive assembly in which 622 depicts structural mounting supports as defined by the geometry of the invention, 623 depicts bearings on the top and bottom of the drive-fan hub, 624, and 625 depicts the position for drive-fan pitch-actuation components. FIG. 19b, depicts a side view of a double drive-motor, 621, double drive-fan drive assembly in which 622 depicts structural mounting supports as defined by the geometry of the invention, 623 depicts bearings on the top and bottom of the drive-fan hub, 624, and 625 depicts the position for drive-fan pitch-actuation components. FIG. 19c depicts a top skeletal view of a four-cell craft in relation to drive motor placem nt in which 521, 522, 523 and 524 depict the lateral and longitudinal centers for drive-fan installation.

Drive motors, 621, can be either rotary internal combustion engines with their drive shafts directly affixed, or by means of a gear-reduction unit, to the drive-fan hub, 624, or electrical, hydraulic or steam motors directly affixed to the drive-fan hub, 624. In the case of utilizing electrical motors, said motors are joined to the primary drive generators by flexible conductive cable. In the case of utilizing hydraulic or steam motors, said motors are connected to primary drive pumps by flexible hydraulic lines. It should be noted that in the cases of utilizing electrical, hydraulic or steam motors, said motors may be connected to either the same relative side of the fuselage primary drive unit or cross over the center-line of fuselage to the opposite side of the fuselage primary drive unit. By connecting to the opposite side more cable or line will be used, increasing system resistance, however, while at the same time reducing crimping of the lines under wing assembly actuation movements.

Although there are many different types of propellers or fans, the structural and aerodynamic geometry of the invention requires at least a three blade, preferably a six, nine or other multiple of three blade, fan or propeller. It should also be noted that drive-fans of different diameters, blade number, blade design and blade pitch may be employed to compensate for non-optimum longitudinal center of gravity. It should also be noted that different types of variable pitch drive-fans may be employed including on-demand and constant speed. Variable pitch drive-fans may serve many purposes including adjusting the longitudinal center of gravity, to an extent regulating the centrifugal suction and thrust of the drive-fans for lift and longitudinal propulsion and also assisting in pitch, roll and yaw maneuvering while the vehicle is in forward motion. Designed centrifugal drive-fans may also be employed.

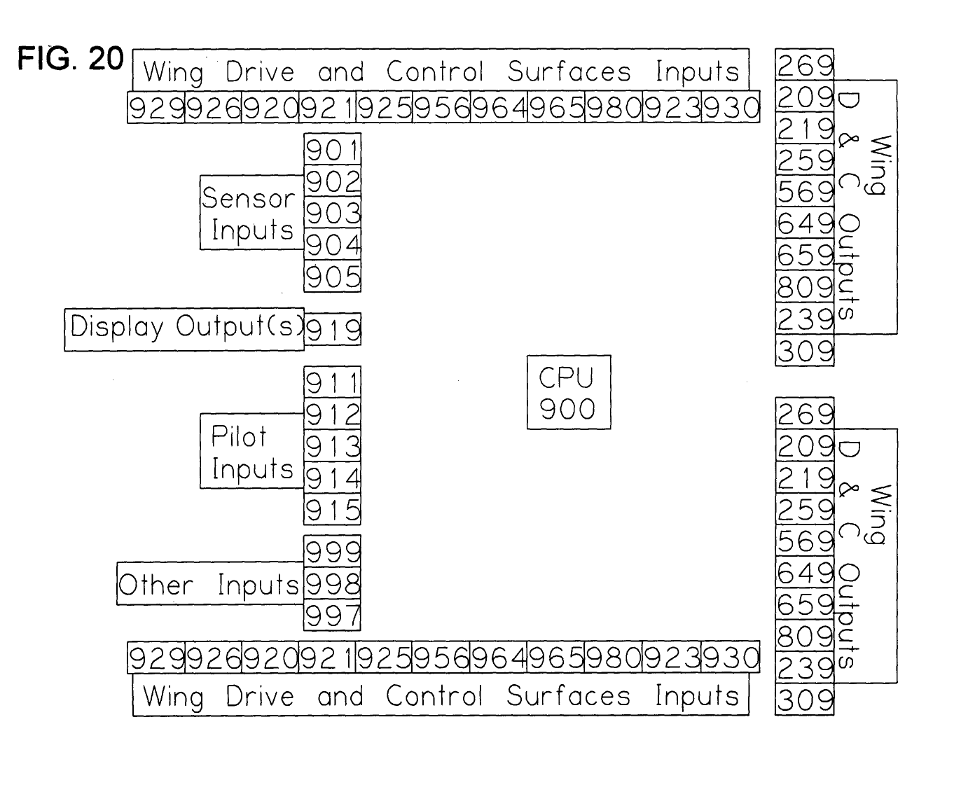

FIG. 20, depicts computer central processing unit (CPU) inputs and outputs for control, propulsion, and navigation. A modular design of CPU capable of processing inputs and outputs is implied by the modularity of the drive systems of vehicles utilizing the invention. The ability of the CPU to process inputs and outputs from two-cell, three-cell, four-cell and other multi-cell vehicles will reduce design time and engineering for separate CPUs and therefore be more cost effective. The similarity in CPU and controls interaction between different vehicles will also allow for pilot/operators to easily adjust to different variants of vehicles that utilize the invention. The CPU must be rendered fail-safe by secure connections to batteries, appropriate fusing and regulation. A dual, or redundant, CPU systems may be also employed to further reduce the chance of systems failure should one CPU become inoperable.

Sensors necessary for the safe operation of vehicles utilizing the invention include: 901, depicts fuel sensor inputs to the CPU, 900. 902, depicts attitudinal gyroscope sensor inputs to the CPU, 900. 903, depicts altitude sensor inputs to the CPU, 900. 904, depicts airspeed sensor inputs to the CPU, 900. 905, depicts lateral slip sensor inputs to the CPU, 900.

Pilot control inputs consist of: 911, depicts pilot joystick or column position sensor inputs to the CPU, 900. 912, depicts pilot throttle position sensor inputs to the CPU, 900. 913, depicts pilot lift/longitudinal thrust control sensor inputs to the CPU, 900. 914, depicts pilot left foot pedal position sensor inputs to the CPU, 900. 915, depicts pilot right foot pedal position sensor inputs to the CPU, 900.

Drive inputs consist of: 929, depicts alternator/starter sensor inputs to the CPU, 900, for amperage output.926, depicts supercharger sensor inputs to the CPU, 900, for on-off position, pressure, and inlet and outlet temperatures. 920, depicts engine sensor inputs to the CPU, 900, for coolant temperature, throttle position, rpm, lubrication pressure, and electrical fuel injection (EFI) inputs. 921, depicts drive-pump sensor inputs to the CPU, 900, for throttle position, pressure and temperature. 925, depicts control surfaces and sub-systems hydraulic pump sensor inputs to the CPU, 900, for throttle position, pressure and temperature. 956, depicts drive-motor sensor inputs to the CPU, 900, for rpm, pressure and temperature.

Control surface inputs consist of: 964, depicts drive-fan pitch actuation position sensor inputs to the CPU, 900, for pitch position of the drive-fans. 965, depicts shroud vent position sensor inputs to the CPU, 900, for open/closed position. 980, depicts control surface position sensor inputs to the CPU, 900, for open/closed position. 923, depicts wing assembly actuation position sensor inputs to the CPU, 900, for open/closed position. 930, depicts sub-wing assembly actuation position sensor inputs to the CPU, 900, for open/closed position.

Other inputs may include: 999, radar input to the CPU, 900. 998, infrared input to the CPU, 900. 997, global positioning system (GPS) input to the CPU, 900.

Modularity of said inputs will allow for the installation of a common CPU in different variants of vehicles that seek to utilize the invention.

269, depicts supercharger outputs from the CPU, 900, for on-off position. 209, depicts engine outputs from the CPU, 900, throttle position. 219, depicts drive-pump outputs from the CPU, 900, for throttle position and pressure control. 259, depicts control surfaces and sub-systems hydraulic pump outputs from the CPU, 900, for throttle position and pressure control. 569, depicts drive-motor sensor outputs from the CPU, 900, if utilizing variable displacement motors, for throttle position and pressure control. 649, depicts drive-fan pitch actuation position outputs from the CPU, 900, for pitch position of the drive-fans. 659, depicts shroud vent position outputs from the CPU, 900, for open/closed position. 809, depicts control surface position outputs from the CPU, 900, for open/closed position. 239, depicts wing assembly actuation position outputs from the CPU, 900, for open/closed position. 309, depicts sub-wing assembly actuation position outputs from the CPU, 900, for open/closed position. 919, depicts pilot systems display outputs from the CPU, 900, to multi-function displays or heads-up displays.

Modularity of said outputs will allow for the installation of a common CPU in different variants of vehicles that seek to utilize the invention.

Propulsion, structures, control and aerodynamics are closely related in the invention.

The best mode for carrying-out the invention is dependent upon the skills and expertise of the builder. Vehicles which seek to utilize the invention, may be constructed of marine/aircraft grade plywood, cloth over metal tube frame, monocoque metal skin and tube frame, composite panels and skin and a combination of the above-mentioned techniques. It is foreseen that composite construction will allow for the greatest strength to weight ratio, though being more labor intensive, while plywood construction will be the easiest method of construction and also while a monocoque metal skin and tube frame will provide the greatest strength and durability.

A great deal of time and labor spent in prototyping can be saved by computer modeling in conjunction with computational fluid dynamics (CFD) programs. CFD analysis may be of great assistance in determining wing assembly dihedral, permeability of panels and surfaces, leading edge angles, structural modifications to increase laminar flow and curvature to surfaces which will further increase laminar flow.

Prototyping for vehicles which seek to utilize the invention, would best be accomplished by first constructing a scale model of a wing assembly out of plywood for a two-cell vehicle, in which structures not common to three-cell and four-cell vehicles may be removed and modules corresponding to said vehicles may be rigidly affixed. This prototype wing assembly with drive-fans and means to drive said fans installed may be constructed in excess of its necessary designed strength, however venting means should be installed as close to desired aerodynamic parameters, as defined by CFD programming, as possible. Wind tunnel tests on this wing assembly may then be carried out for two-cell, three-cell and four-cell variants to ascertain laminar flow and how it is effected by changes in dihedral, drive-fan speed and intake and exhaust venting and actuation of control surfaces. Once suitable aerodynamic parameters and characteristics for wing assemblies for different variants of vehicles utilizing the invention are ascertained non-modular, mirror images, of said wing assemblies may be constructed, while paying closer attention to structural elements designed to strength and weight parameters. These modular and non-modular wing assemblies may then be affixed by hinges to a modular mock-up of the fuselage with wing assembly actuators also installed. Wind-tunnel testing may then be continued to ascertain the aerodynamic parameters and characteristics for the vehicles and how they are effected by changes in dihedral, drive-fan speed and intake and exhaust venting and actuation of control surfaces. Changes in fuselage and wing-assembly shape may then be made to optimize the aerodynamics of given vehicle variants.

Once the aerodynamics of the vehicles are suitably established and refined by further CFD analysis, structural elements can be designed to their optimum strength to weight ratios, for the different construction techniques, and full-scale prototype vehicles, with primary drive and control components installed, may be built and suitable centers of gravity, with pilot/operator/passenger and fuel capacities taken in to consideration, established. Further wind tunnel testing with drive-fans of different blade number, aerodynamic profiles and diameters, under variable power settings under different movements, wing assembly dihedral and control surface actuation may be performed before test flights. Test flights should be first conducted in ground-effect on a body of water, thereby increasing the safety of the test pilot. Free-flight testing may only be performed after the vehicle has been proven it may be safely operated in ground-effect.

Controls for vehicles utilizing the invention should be kept as simple as possible. A multi-axis joystick or column is employed with right/left movements on the stick or turning of the control wheel on a column acting to turn the vehicle right/left or moving the vehicle right/left laterally depending upon the position of the lift/longitudinal thrust control. Forward/back movements on the stick making the vehicle move forward/back or down/up also depending upon the position of the lift/longitudinal thrust control. The throttle lever controls the thrust of the drive-fans. Different settings may be employed for ground effect, lift to maximum ground effect, and maximum output for lift and/or longitudinal propulsion. A lift/longitudinal lever with different settings may be employed for selection of lift, lift/longitudinal propulsion and longitudinal propulsion, generally the propulsion attitude of the vehicle. One foot pedal may serve as a clutch/brake to reduce the speed of the drive-fans via engine, generator or pump speed or output. The other foot pedal may serve as a thrust accelerator. Movement of the above-mentioned controls are then processed by the CPU in conjunction with other sensor inputs before output impulses are sent to the drive units, drive-fan blade pitch actuators, wing assembly dihedral actuators and control surfaces actuators, creating controlled lift, pitch, roll, yaw and longitudinal/lateral propulsion movements. The CPU will also make rapid, small scale of magnitude corrections to outputs controlling the drive units, drive-fan blade pitch actuators, wing assembly actuators and control surface actuators to maintain desired speed, direction and attitude while reducing radical pitch, roll and yaw movements that will endanger the vehicle.

It should be noted that vehicles that utilize the invention may be designed to function strictly in ground-effect. By using common controls and CPUs, potential pilot/operators for VTOL flight versions may be first trained in ground-effect vehicles and once proficient may move on to VTOL flight variants. As the piloting of ground-effect vehicles does not yet require operators to posses a pilot's license, ground-effect vehicles will be a natural first step in learning to operate vehicles that utilize the invention.

The current invention has been described in specific vehicle embodiments with specific components, structure and surfaces, however, it is anticipated that changes to the invention may become apparent to those skilled in arts related to the invention. It is therefore intended by the inventor that the subsequent claims be interpreted as addressing such changes.

1. A method of propulsion and attitude control applicable to all fluid environments in which longitudinal propulsion is created by longitudinally adjacent, counter-rotating, drive-fans mounted on approximately vertical axes within airfoil wing assemblies which draw fluid from the ambient environment through controllable louvered vanes and vents, fixed structures of variable permeability, and door-like sub-wing assemblies located on the exterior of the wing assemblies as well as from vents arranged around the periphery of the cylindrical shrouds surrounding each drive-fan, fluid is then controllably exhausted by shroud venting means through exhaust vents at the aft and outer wingtips of the wing assemblies by the centrifugal thrust of the drive-fans, longitudinal propulsion as described is augmented by the swirl effect of the drive-fans on the surrounding ambient fluid medium as fixed permeable or controllable louvered vane intakes and exhausts that are located directly above and below the drive-fans are arranged such that the drive-fans are exposed to the ambient fluid medium at the aft-ward rotation of the drive-fans;
V/STOL lift propulsion is likewise derived from the controlled influx of fluid through the means mentioned above that is then controllably exhausted downward approximately perpendicular to the longitudinal line of the vehicle through venting means located on the bottom of the wing assemblies, lift propulsion as described is augmented by the heat derived from primary drive components, which is drawn into the drive-fans and exhausted vertically downward to create increased lift, by giving the drive-fan blades a negative pitch, the above-mentioned lift functions are reversed and controllable, submersible descent may be achieved; and
by regulating the fluid flow to and from the respective drive-fans, between drive-fans of the same wing assembly and between the respective wing assemblies by venting means mentioned above to control longitudinal and lift propulsion in conjunction with actuating the dihedral of the wing assemblies, trailing edge control surfaces, and the vectoring of longitudinal thrust from the aft and wing-tip exhaust vents, coordinated control of lift, pitch, roll, yaw, and lateral and longitudinal thrust is achieved.

2. A vehicle that integrates at least one left and one right wing assembly with a centrally located fuselage to create a fluid dynamic body, the structural geometry of said vehicle utilizing the invention is substantially triangulated longitudinally and laterally, with the wing assemblies being constructed around cylindrical drive-fan shrouds, which are in turn arranged within a hexagonal-cell framework, the intersection of lines bisecting these hexagonal-cell structures serve as centers for the mounting of the drive-fans and drive components, wherever possible, lateral and longitudinal triangulation is used for strength and conservation of weight, while the geometry of the invention also allows for variable mounting points for vertical, structural triangulation where necessary, each respective wing assembly is of an airfoil profile that may be modified in camber, thickness and lateral curvature to suit specific performance and role requirements;
each wing assembly houses at least two longitudinally adjacent, counter-rotating, drive-fans mounted on fixed, approximately vertical axes within their own respective cylindrical shrouds, and are capable of being powered by different means, including: rotary combustion engines, electric, hydraulic, and/or steam motors, each shroud has operable venting means arranged around the periphery that regulate the direction and volume of centrifugal fluid flow to and from each respective drive-fan, each wing assembly has controllable exterior venting located directly above and below the drive-fans and/or fixed permeable, semi-permeable and non-permeable surfaces that regulate fluid flow over and under each respective wing assembly to create a dynamic laminar envelope around the vehicle as well as regulating the direction and volume of fluid flow to and from the drive-fans to create coordinated lift, pitch, roll and yaw movements as well as longitudinal and lateral thrust and braking, each wing assembly has at least one leading edge vent that may be controlled to regulate fluid flow into the forward drive-fan shroud, each wing assembly has venting means located adjacent to the fuselage to allow heat to be drawn from primary drive components in the case of utilizing electric, hydraulic, and/or steam motors on the drive-fans and to allow for fluid flow from venting structures and/or fixed permeable or semi-permeable structures located on the leading edge and top of the fuselage, each wing assembly has at least one controllable vent located on the outside edge of the wing assembly that regulates fluid flow from the adjacent drive-fan shroud to control lift, pitch, roll and yaw as well as longitudinal and lateral thrust, each wing assembly has at least one controllable aft vent that regulates fluid flow from the aft drive-fan shroud to control lift, pitch, roll and yaw as well as longitudinal and lateral thrust, each wing assembly has at least one trailing edge split-type flap and/or aileron mounted on the top and/or bottom of the wing assembly to control pitch, roll and yaw movements, each wing assembly has at least one top and/or bottom aft tail surface to control the vectoring of fluid exhaust from the aft exhaust vent as well as effecting pitch, roll and yaw movements, each wing assembly may be hinged to pivot up and/or down, thereby effecting the dihedral of the entire wing assembly, to control yaw, roll and pitch movements, lateral center of gravity and fluid flow to and from each respective drive-fan shroud and between left and right wing assemblies; and
the fuselage houses a central, forward cabin/cockpit, with primary drive components, in the case of utilizing electric, hydraulic and/or steam drive motors on the drive-fans, being located between the cabin/cockpit and wing assemblies, the area directly aft of the useable cockpit/cabin area may serve as a fluid passageway between wing assemblies which may be used to control fluid flow between left and right wing assemblies to coordinate lift, pitch, roll, yaw, lateral thrust and fluid pressure variances which occur between left and right wing assemblies during different movements, the surfaces located directly above said area may be of a permeable or semi-permeable construction, fuselage top surfaces adjacent to the wing assemblies may be of permeable or semi-permeable construction as fluid is also inducted into the wing assembly drive-fans from the fuselage through venting means located between the fuselage and the wing assemblies, located at the extreme aft of the fuselage may be a vertical tale and rudder assembly to control turning movements that may also consist of a horizontal elevator or split elevators mounted to the top of the tail assembly to effect lift, pitch, roll and yaw.

3. A vehicle as recited in claim 2 wherein said vehicle can be constructed using varied techniques common knowledge to marine and aircraft construction including: marine/aircraft grade plywood, fabric over metallic tube frame, monocoque skin and frame, composite core and/or a combination of the above-mentioned.

4. A vehicle as recited in claim 2 wherein said vehicle can be built to any size from remote-controlled scale model or toy to mass transport or cargo.

5. A vehicle as recited in claim 2 wherein drive-fan cell modules of a hexagonal shape and their relevant aerodynamic and structural elements may be added, longitudinally and laterally, to increase the performance of said vehicle.

6. A vehicle as recited in claim 2 wherein the fuselage, as viewed from above, may be modified by selective inward or outward pivoting of the fuselage halves in regard to each other and adding structures or modifying existing structural elements or by splitting the fuselage and adding a uniform spacing between fuselage halves to create smaller or larger frontal areas and respective cockpit/cabin area while also making it possible to add auxiliary longitudinal propulsion means.

7. A vehicle as recited in claim 2 wherein the primary drive unit in a electrical, hydraulic or steam variant of said vehicle is of a modular design with primary movers and generators or pumps added as drive-fan cells are added.

8. A vehicle as recited in claim 2 wherein the closed, non-actuated, dihedral of each wing assembly may be of a negative, positive or neutral dihedral and has means to be controllably pivoted from a negative dihedral to a positive dihedral, neutral dihedral to a positive dihedral, neutral dihedral to negative dihedral and/or negative dihedral to a positive dihedral.

9. A vehicle as recited in claim 2 wherein the primary drive means to power primary drive electric generator(s), hydraulic drive pump(s) or steam generators/pumps can be of various types including: internal combustion rotary or piston, turbo shaft, or nuclear steam reactor.

10. A vehicle as recited in claim 2 wherein the drive-fans utilized may be of different types including: fixed axial, variable pitch axial, fixed pitch centrifugal, variable pitch centrifugal and/or a combination of the above-mentioned.

11. A vehicle as recited in claim 2 wherein the drive-fans utilized may be of different relative sizes, blade number or blade profile to create a balanced lifting platform in regard to longitudinal center of gravity and longitudinal propulsion characteristics.

12. A vehicle as recited in claim 2 wherein a computer of modular design for sensor inputs and control outputs senses the attitude, altitude and velocity of the vehicle, pilot/operator control inputs, speed and output of primary drive components and drive-fans, and the position of drive-fan pitch actuators, wing assembly dihedral actuators, and control surface actuators and then processes said inputs, while making minute corrections, into outputs to control the above-mentioned drive and control surface components and structures, to create stable and controlled motion of the vehicle.

13. A vehicle as recited in claim 2 wherein a vertical stabilizer, t-tail or v-tail is affixed to the aft of the fuselage.
